(19) United States
(12) Patent Application Publication
(10) Pub. No.: US 2022/0249920 A1
(43) Pub. Date: Aug. 11, 2022

(54) SYSTEM AND METHOD FOR MANUFACTURE OF GOLF CLUB WITH POLYMER INJECTION

(71) Applicant: James Patrick Harrington, San Diego, CA (US)

(72) Inventor: James Patrick Harrington, San Diego, CA (US)

(21) Appl. No.: 17/665,842

(22) Filed: Feb. 7, 2022

Related U.S. Application Data
(60) Provisional application No. 63/147,325, filed on Feb. 9, 2021.

(51) Int. Cl. A63B 53/04; B29C 45/00; B29C 45/02

(52) U.S. Cl. CPC A63B 53/047; A63B 53/0408; A63B 2102/32; B29C 45/02; B29C 45/0001

(57) ABSTRACT

An improved golf club head is provided having a striking face portion, a topline, a heel portion adapted to receive a shaft, a toe portion, and a sole. The improved golf club head includes port holes extending from one or more cavities to allow insertion of a polymer and metal shot into the golf club head. The insertion of a polymer and metal shot facilitates increasing weight and/or biasing weight distribution of the golf club head. The improved golf club head may be manufactured by forging the main body of the golf club head, machining a recess into the main body, and attaching an insert in the recess. The recess forms a cavity and allows a port hole to facilitate insertion of the polymer and metal shot into the golf club head. After insertion, the polymer is cured to form the golf club head.

### CROSS REFERENCE TO RELATED APPLICATIONS

This application claims the benefit of U.S. Provisional Patent Application 63/147,325, which was filed on Feb. 9, 2021, the entirety of which is hereby fully incorporated by reference herein.

### FIELD OF THE DISCLOSURE

This disclosure relates generally to golf clubs and more specifically to golf club heads.

### OVERVIEW

Wedges and irons are types of golf clubs. Wedges and irons are generally used by golfers to hit shots with golf balls resting directly on the turf (e.g. grass, sand, dirt, hardpan or other ground surface) of a golf course. Irons and wedges are similar to each other and loft differentiates irons from wedges. Irons and wedges together have loft range of 17-70 degrees. The typical loft range for irons is from 17-82 degrees. The typical loft range for wedges is from 43-70 degrees. Since an iron and a wedge have similar characteristics, the terms iron(s) and wedge(s) are used interchangeably herein unless specifically stated otherwise.

Given that the sole of irons and wedges are the part of the golf club head that has the most surface area that contacts the turf, the design of the sole profile often has a significant impact on turf interaction with the golf club and resulting quality of the shot. Improper turf engagement prior to or during the striking of the golf ball can be detrimental to the quality of the golf shot resulting in “fat shots”, “thin shots”, “chuck shots” or other non-desirable and/or unpredictable shots.

Golf club heads may be manufactured with various weight distributions providing different balances and swing characteristics. Weight may be distributed to bias weight towards, for example, the heel, the toe, or the heel and toe of a golf club. When weight of a golf club head is biased towards the toe, the golf club is referred to as toe weighted. With this weight distribution, the toe rotates slower and results in an open club-face on impact. An open club-face produces spin that leads to fades or slices. In other words, the ball has a flight pattern that travels more to the right of right-handed players and more to the left of left-handed players. When weight of a golf club head is biased towards the heel, the golf club is referred to as heel weighted. With this weight distribution, the heel rotates slower, creating a closed club-face on impact. A closed position leads to draws and hooks. In other words, the ball has a flight pattern that travels more to the left for right-handed players and more to the right for left-handed players. When weight is added to both the heel and the toe, a larger sweet spot is created. The sweet spot refers to the optimal location on a golf club face to strike the ball. Heel-toe weighted golf club heads are favored by amateur players who benefit from the added forgiveness of a golf club with a larger sweet spot.

Generally, golf club heads are forged in a shape having a particular fixed weight distribution. However, it may be prohibitively expensive to manufacture golf club heads with every weight distribution that may be desired by golfers. Some golf clubs have sliding or insertable weights that can be attached to golf clubs to adjust golf club head balance. These sliding or otherwise adjustable weight systems allow a golf club to be fitted to adjust the balance and gameplay of a golf club for a particular golfer. However, these systems do not reliably join materials together. Due to stress placed on golf club heads upon impact, connections may loosen and may result in weights shifting, moving freely, or breaking loose, thereby changing the balance of the golf club head.

For the reasons stated above, and for other reasons stated below which will become apparent to those skilled in the art upon reading and understanding the disclosure, there is a need in the art for an improved manufacturing and versatility of golf clubs.

It is an object of the disclosure to provide a golf club head configured to facilitate production of a plurality of golf club heads having various weight distributions.

Another object of the disclosure is to provide a golf club head that may be configured after manufacture to produce golf club heads for a plurality of balance characteristics.

Yet another object of the disclosure is to provide a golf club head that facilitates biasing weight towards the heel of the golf club head.

Another object of the disclosure is to provide a golf club head that facilitates biasing weight towards the toe of the golf club head.

Yet another object of the disclosure is to provide a golf club head that facilitates permanent adjustment of weight and/or balance of the golf club head.

Another object of the disclosure is to provide a golf club head that facilitates adjustment of weight and/or balance of the golf club head in an intuitive manner.

Yet another object of the disclosure is to provide a golf club head that facilitates easy adjustment of weight and/or balance of the golf club head.

Another object of the disclosure is to provide a golf club head having a long useful life.

Yet another object of the disclosure is to provide a golf club head that is strong, robust, and durable.

Another object of the disclosure is to provide a golf club head that is high quality.

These and other objects, features, or advantages of the disclosure will become apparent from the specification, figures and claims.

### BRIEF DESCRIPTION OF THE DRAWINGS

FIG. 1 is a front view of a golf club head, in accordance with one or more embodiments.

FIG. 2 is a partial front view of a golf club head, in accordance with one or more embodiments; the view showing the golf club head segmented along a midline.

FIG. 3 is a front view of a golf club head, in accordance with one or more embodiments; the view showing the sole contact surface of the golf club head.

FIG. 4 is a top view of a golf club head , in accordance with one or more embodiments.

FIG. 5 is a cross section toe side view of a golf club head, in accordance with one or more embodiments.

FIG. 6 is a cross section toe side partial view of a golf club head, in accordance with one or more embodiments, the view showing sole geometry of the golf club head.

FIG. 7 is a cross section toe side partial view of a golf club head, in accordance with one or more embodiments, the view showing sole geometry of the golf club head.

FIG. 8 is a close-up cross section toe side view of a golf club head, having improved sole geometry, in accordance with one or more embodiments; the view showing trailing edge relief.

FIG. 9 is a cross section toe side view of silhouettes of a traditional golf club along with three golf clubs having improved sole geometry configured for a high bounce, mid bounce, and low bounce, in accordance with one or more embodiments.

FIG. 10 is a close-up cross section toe side view of silhouettes of a golf club with a conventional sole along with three golf clubs having improved sole geometry configured for a high bounce, mid bounce, and low bounce, in accordance with one or more embodiments.

FIG. 11 shows camber area and bounce triangle area of a cross section toe of a traditional golf club.

FIG. 12 shows camber area and bounce triangle area of a cross section toe of a second traditional golf club.

FIG. 13 shows a table listing sole width, sole camber area, sole width bound line angle, bounce triangle area, sole camber percentage, and camber to bounce ratio for two traditional golf club heads along with ten example golf club heads having improved sole geometry.

FIG. 14 is a front view of a golf club head, in accordance with one or more embodiments.

FIG. 15 is a left view of the golf club head shown in FIG. 14, in accordance with one or more embodiments.

FIG. 16 is a top-back perspective view of the golf club head shown in FIG. 14, in accordance with one or more embodiments.

FIG. 17 is a right view of the golf club head shown in FIG. 14, in accordance with one or more embodiments.

FIG. 18 is a bottom view of the golf club head shown in FIG. 14, in accordance with one or more embodiments.

FIG. 19 is a top view of the golf club head shown in FIG. 14, in accordance with one or more embodiments.

FIG. 20 is a left-back perspective view of the golf club head shown in FIG. 14, in accordance with one or more embodiments.

FIG. 21 is a back-bottom perspective view of the golf club head shown in FIG. 14, in accordance with one or more embodiments.

FIG. 22 is a close up view of the view shown in FIG. 21, in accordance with one or more embodiments.

FIG. 23 is a back exploded view of a golf club head, in accordance with one or more embodiments; the view showing shapes of materials filling cavities of the golf club head.

FIG. 24 is a back left exploded view of a golf club head, in accordance with one or more embodiments; the view showing shapes of materials filling cavities of the golf club head.

FIG. 25 is a back exploded view of a golf club head, in accordance with one or more embodiments; the view omitting the back insert of the golf club head; the view showing cavities of the golf club head filled by materials.

FIG. 26 is a lower back exploded view of a golf club head, in accordance with one or more embodiments; the view showing shapes of materials filling cavities of the golf club head.

FIG. 27 is a lower back exploded view of a golf club head, in accordance with one or more embodiments; the view showing shapes of materials filling cavities of the golf club head.

FIG. 28 is a back left assembled view of a golf club head, in accordance with one or more embodiments; the view showing shapes of materials filling cavities of the golf club head; the view showing the golf club head having a port hole for insertion of materials into a cavity.

FIG. 29 is close up view of the port hole of the golf club head shown in FIG. 28, in accordance with one or more embodiments.

FIG. 30 is an upper back assembled view of a golf club head, in accordance with one or more embodiments; the view showing a back insert having a pair of port holes for insertion of materials into a cavity, in accordance with one or more embodiments.

FIG. 31 is close up view of the port hole of the golf club head shown in FIG. 30, in accordance with one or more embodiments.

FIG. 32 is a view of the golf club head shown in FIG. 33, in accordance with one or more embodiments; the view showing the back insert of the golf club head omitted; the view showing cavities of the golf club head filled by materials.

FIG. 33 is a view of the golf club head shown in FIG. 32, in accordance with one or more embodiments; the view showing a cover placed over the pair of port holes of the golf club head.

FIG. 34 is an example process for manufacture of a golf club head, in accordance with one or more embodiments.

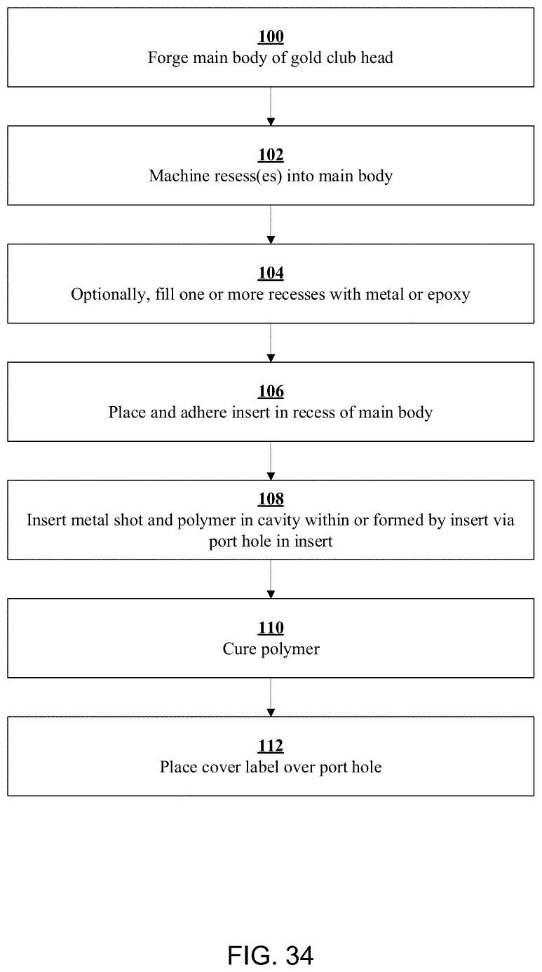

FIG. 35 is an example weight matrix indicating amounts of tungsten to be added into recesses of the golf club head to provide a desired weight, in accordance with one or more embodiments.

### SUMMARY OF THE DISCLOSURE

In one or more embodiments, a golf club head is provided. The golf club head is comprised of a striking face portion located at a frontal portion of the golf club head, a topline located at an upper portion of the golf club head, a heel portion located at a proximal end of the golf club head and adapted to receive a shaft, a toe portion located at a distal end of the golf club head opposite the heel portion, and a sole, located at a lower portion of the golf club head. In this example embodiment, the golf club head includes one or more cavities that are positioned within the golf club head. In this example embodiment, the golf club has port holes extending from the one or more cavities to a surface of the golf club head to allow insertion of a polymer and metal shot into the one or more cavities which facilitate increasing weight and/or biasing weight distribution of the golf club head.

In one or more embodiments, a method for manufacture of golf club heads is provided. A main body is forged having a striking face portion located at a frontal portion of the golf club head. The golf club head is comprised of a topline located at an upper portion of the golf club head, a heel portion located at a proximal end of the golf club head that is adapted to receive a shaft, a toe portion located at a distal end of the golf club head opposite the heel end, a sole portion located at a lower portion of the golf club head, and a back located at a rear portion of the golf club head. In this example embodiment, a recess is machined in the back of the main body. An insert is attached to the main body in the recess. In this example embodiment, the insert forms a first cavity. The insert has a first port hole extending from the first cavity to a surface of the golf club head. Metal shot and a polymer are inserted into the first cavity through the first port hole. The polymer is then cured to form the golf club head.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of golf clubs. However, the embodiments are not so limited. It is appreciated that the embodiments may be adapted for use in other applications which may be improved by the disclosed structures, arrangements and/or methods. The system is merely shown and described as being used in in the context of golf clubs for ease of description and as one of countless examples.

Golf Club System 10:

With reference to the figures, a golf club system 10 for adjusting the balance of a golf club head is disclosed. In the arrangement shown, as one example, the golf club system 10 includes a golf club head 14 connected to a shaft among other components.

Golf Club Head 14:

Golf club head 14 is formed of any suitable size shape and design and is configured to facilitate adjusting the balance of the golf club head. In the arrangement shown, as one example, the golf club head includes a main body 16 having a striking face 18 located at a frontal portion of the golf club head 14, a topline 20 located at an upper portion of the golf club head 14, a heel 22 portion located at a proximal end of the golf club head 14, a hosel 24 located at the heel 22 and adapted to receive shaft, a toe 26 portion located at a distal end of the golf club head 14 opposite the heel 22 end, a sole 28 located at a lower portion of the golf club head 14 opposite the topline 20, a back 30 located opposite the striking face 18, and one or more cavities positioned within the golf club head 14, among other components. The sole 28 extends from a leading edge 32, where the striking face 18 meets the sole 28, to a trailing edge wherein the sole 28 meets the back 30 of the golf club head 14. As used herein, the “leading edge point” 34 of a cross section refers to the most forward point of the cross section of the golf club head 14 when the hosel 24 and shaft are positioned in a plane perpendicular to a horizontal ground plane 68 and the golf club head 14 is positioned at its proper lie angle (e.g., when the score lines on strike face 18 are parallel to the ground).

As used herein, the “trailing edge point” 38 of a cross section of a golf club head refers to the point of the cross section where a rear edge of the sole 28 meets a lower edge of the back 30 of the golf club head 14. As used herein, the “sole contact point” 40 of a golf club head refers to the lowest point of the sole of the cross section when the hosel 24 and shaft are positioned in a plane perpendicular to a horizontal ground plane 68 and the golf club head 14 is positioned at its proper lie angle.

As used herein, the line from the leading edge point 34 to the trailing edge point 38 is referred to as the “club width bounce line” 42. As used herein, “leading edge height” 44 refers to the vertical distance between the leading edge point 34 to the sole contact point 40. As used herein “club width” 64 refers to the horizontal distance between the leading edge point 34 to the trailing edge point 38. As used herein, “club width bounce angle” 66 refers to the angle of the club width bounce line 42 relative to the horizontal ground plane 68.

In the example golf club system 10 shown in the figures, the shown cross sections are along a YZ-plane located at a midline 46 of the golf club head 14. Wherein the YZ-plane extends in a perpendicular planar alignment to a plane established by the strike face 18 or face of the golf club head 14. In the arrangement shown, as one example, the “midline” 46 is located at the sole contact point 40 along the X axis. In the arrangement shown, the midline 46 extends vertically on the Y axis from the sole contact point 40. From there a cross section is created on the YZ-plane on the midline 46. In this way, the midline 46 establishes a plane that extends in perpendicular planar alignment to the generally flat plane of the striking surface of the golf club head 14. In the arrangement shown, as one example, the midline 46 extends perpendicular to the score lines 36 that extend along the striking face 18 of the golf club head 14. In the arrangement shown, as one example, the score lines 36 extend in parallel alignment to the X axis.

Sole Contact Point 40—Tangent Point:

In one arrangement, as one example, the sole contact point 40 is a tangent point. That is, the sole contact point 40 is a single point on the golf club head 14 at which the curvature of the golf club head 14 trails off forward (toward the leading edge 32), rearward (toward the trailing edge) and to the sides (toward the heel 22 and toward the toe 26) of the sole contact point 40. In this arrangement the midline 46 is located at the tangent point that is the sole contact point 40.

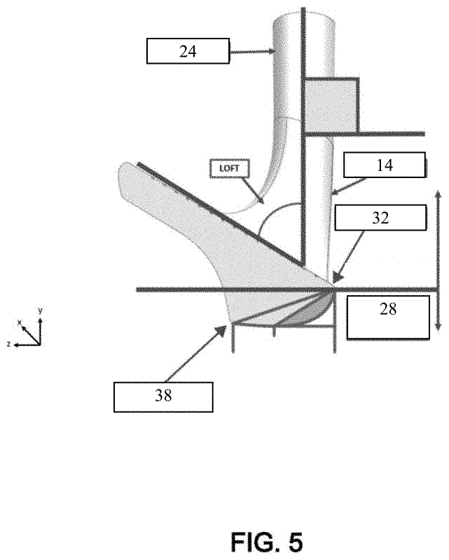

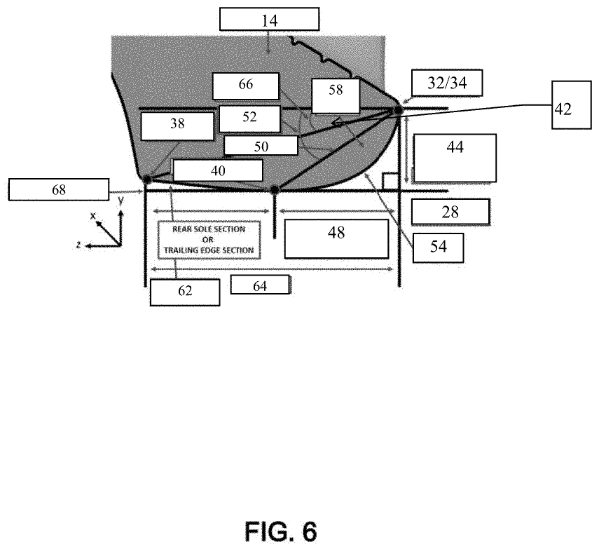

In the arrangement shown in FIG. 5 and FIG. 6 the sole contact point 40 is in contact with the horizontal ground plane 68, the plane established by the midline 46 is in perpendicular alignment with the horizontal ground plane 68, and the hosel 24 and shaft are positioned in perpendicular alignment (a vertical alignment) to the horizontal ground plane 68 when viewed from the toe 26 to the heel 22.

Sole Contact Point 40—Plane:

In another arrangement, as one example, the sole 28 does not have curvature from heel 22 to toe 26 at a single point where the sole 28 contacts the horizontal ground plane 68. In this example, while the score lines 36 are parallel to the horizontal ground plane 68, the midline 46 may be located approximately at the center point of the sole contact point 40 or sole contact surface from heel 22 to toe 26 on the X axis. In this arrangement, the sole contact point 40 or sole contact surface can extend the entire area of the sole 28 or lower portion of the golf club head 14 from heel 22 to toe 26 or any portion thereof. In this arrangement, the sole contact point 40 or sole contact surface creates a flat section that is parallel to the horizontal ground plane 68 and extends the length of the golf club head 14 from the heel 22 to the toe 26.

Effective Bounce:

It is important to have an optimal level of effective bounce on the sole 28 of the golf club head 14 when the golf club head 14 impacts a golf ball. Effective bounce describes the resistance to digging, catching, or snagging of the iron or wedge into the turf. The ideal level of effective bounce is dependent on the individual golfer's swing and sole 28 geometry of the golf club. All golf swings are unique and may require a different level of effective bounce to provide the ideal effective bounce for the individual golfer in order to produce the most efficient turf interaction. Too little effective bounce, and the golf club head 14 will be more apt to cut and dig into the turf much like a knife. Too much effective bounce, and the golf club head 14 will be more apt to bounce off of the ground and result in a thin shot. This happens because the height of the leading edge 32 at impact with the golf ball is higher than the striking face 18 of the golf club head 14. The correct level of effective bounce during a golf swing will yield a more efficient, consistent, and forgiving golf shot.

There are three primary elements that define sole geometry. They are the sole width 48, sole width bounce angle 52, and camber, more specifically forward camber 54. “Sole width” 48 refers to the horizontal distance between the leading edge point 34 and the sole contact point 40. The line from the leading edge point 34 to the sole contact point 40 is referred to as the “sole width bounce line” 50. “Sole width bounce angle” 52 refers to the downward angle of the sole width bounce line 50 from a horizontal plane when the sole contact point 40 is in contact with the horizontal ground plane 68 and when the plane established by the midline 46 is in perpendicular alignment with the horizontal ground plane 68, and when the hosel 24 and shaft are positioned in a perpendicular alignment (a vertical alignment) to the horizontal ground plane 68 when viewed from the toe 26 to heel 22 as is shown in FIG. 5 and FIG. 6 as examples. As used herein, “forward camber” 54 refers to any amount of curvature of the sole 28 of a golf club head 14 extending in front of the sole width bounce line 50.

Generally, as the bounce angle increases while having a fixed sole width 48, the leading edge height 44 will increase, thus increasing the effective bounce. As the sole width 48 increases, the surface area also increases which helps the iron or wedge resist digging into the turf and thus increasing the effective bounce. Lastly, the increase of forward camber 54 increases effective bounce by creating more surface area through a curved surface and restricts the leading edge 32 from contacting the turf first.

As the design of conventional wedges and irons has progressed, effective bounce has been increased primarily by increasing the sole width bounce angle 52 and/or the sole width 48 of the golf club head 14. In this period of progression, marginal adjustment to forward camber 54 have been made but it has not been a primary mechanism for increasing effective bounce. The reason for this may be because wedges and irons started with minimal to no camber, and maximum camber is the opposite of the original design of the wedge. This could be a reason why maximizing forward camber 54 is the last major transformation of the sole 28 of a wedge.

Improved Sole Geometry:

In contrast to traditional design philosophy, it has been surprisingly discovered that significantly increasing the forward camber 54 and reducing sole width 48 of wedges and irons results in a sole 28 profile that provides superior performance. One or more embodiments of the present disclosure are directed to wedge and iron golf club heads 14 having improved sole geometry with significantly increased forward camber 54 and shorter sole width 48 in comparison to conventional wedges and irons.

To better characterize the forward camber 54 of the described embodiments, the terms “sole camber area” 58, “bounce triangle area” 60, and “sole camber percentage” are introduced. As used herein, “sole camber area” 58 refers to the area, in a cross section of a golf club head 14, in which the sole 28 extends in front of the sole width bounce line 50. As used herein, “bounce triangle area” 60 refers to the area, in a cross section of a golf club head 14, that is bounded by the sole width bounce line 50, a vertical line positioned at the leading edge point 34, and a horizontal line positioned at the sole contact point 40. The bounce triangle area 60 encompasses the sole camber area 58. The bounce triangle area 60 is the maximum potential area of the sole camber area 58 at its specific sole width 48 and sole width bounce angle 52. The “Sole camber percentage” of a cross section of a golf club head 14 is calculated by the following formula:

### Sole Camber Percentage Formula

Sole Camber Percentage %=(100*Sole Camber Area)/Bounce Triangle Area.

Conventional wedges and irons generally have a sole with a large sole width 48 and little camber. More specifically, conventional wedges and irons typically have a sole camber percentage of approximately 40-58% and also have a sole width 48 of greater than or equal to approximately 15 mm.

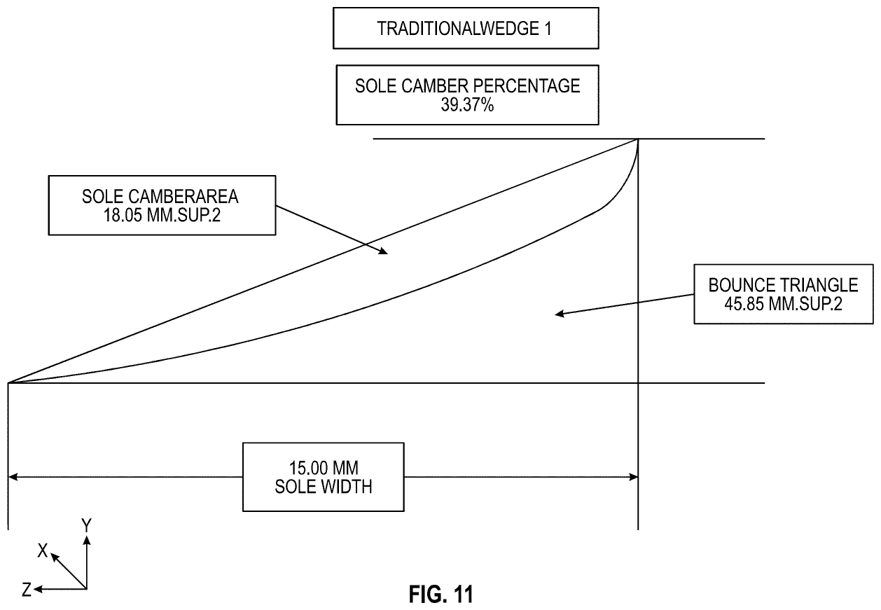

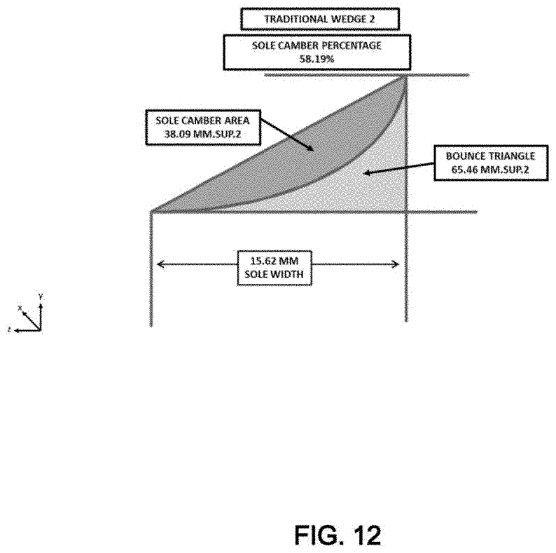

FIGS. 11 and 12 show two examples of conventional wedges. For example, the traditional wedge shown in FIG. 12 has a sole width 48 of 15.62 mm and a sole camber percentage of 58.19%. Wedges with a sole width 48 of less than about 15 mm have not utilized forward camber 54 to its maximum. For example, the traditional wedge shown in FIG. 11 has a sole width 48 of 15 mm and a sole camber percentage of 39.37%. As these examples show, increasing forward camber 54 remains uncharted geometry in the sole 28 design of an iron or wedge golf club.

In contrast to conventional golf club heads, in one or more arrangements, a golf club head 14 is provided that is configured with a sole 28 geometry having a sole width 48 of less than 15 mm and a sole camber percentage greater than 40% (preferably approximately 59% or more). It has been found that increasing this sole camber percentage with this criteria increases the effective bounce and creates a more efficient interaction with the turf through impact of the golf ball. It has also been found that increasing sole camber percentage and restricting sole width 48, as described herein, restricts the leading edge height 44 more than conventional wedges.

In the arrangements shown, the improved sole 28 geometry of the example golf club heads 14 produce a more consistent, efficient, and forgiving golf shot for both irons and wedges in comparison to conventional irons and wedges. In the example arrangements, the sole 28 curvature transitions to the leading edge 32 from the sole contact point 40 of the wedge, which creates a more blunted leading edge 32 than is seen in traditional wedges, which increases effective bounce. In the example arrangements, effective bounce is increased because the improved sole 28 geometry increases the effective bounce of the wedge by further resisting the leading edge 32 from digging, catching, and snagging the turf in comparison to traditional wedges. In the example arrangements, golfers may experience increases in performance because of a more effective bounce is created in the first 15 mm of sole width 48 or forward sole section.

In the example arrangements, the improved sole 28 geometry of the golf club head 14 limits excess turf engagement when the wedge contacts the turf prior to the golf ball. Through careful observation, it has been surprisingly discovered that for optimal performance of sole 28 geometry, sole width 48 should be less than 15 mm and increased sole camber percentage should be greater than or equal to 40% (preferably approximately 59% or more).

The improved sole 28 profile created by the above criteria results in the consistent turf interaction that a professional golfer demands, and that same consistency translates to forgiveness that all golfers need. Additionally, the improved sole 28 geometry provides increased performance for both low handicap golfers as well as high handicap golfers.

It has been observed in testing and evaluation that the disclosed golf club head 14 provides a better feel, improved ability to go through the ground, and is generally easier to control in comparison to other golf clubs on the market.

In the arrangement shown, the improved sole 28 geometry of the golf club head 14 also limits divot depth upon impact. The curved surface provided by the improved sole 28 geometry offers a smoother entry and exit out of the divot by decreasing the divot entry angle and the divot exit angle. Additionally, during the golf swing, golfers can feel a level of push back created by the ideal level of effective bounce provided by the disclosed sole geometry through turf interaction.

In the arrangements shown, the improved sole 28 geometry of the golf club head 14 is more forgiving on miss-hits. When a golfer swings a wedge and impacts the turf prior to the golf ball, a poor shot can result. If the wedge hits behind the golf ball and does not have enough effective bounce on the sole, the leading edge will dig too much into the ground and cause the golfer to hit the ball “fat” or “chunk it” or “hit it heavy”. This is commonly referred to as a “chunk shot”. This sort of hit is defined as when the wedge or sole 28 digs into the turf too much before contact with the golf ball, causing momentum and energy to be decreased, and the golf ball to not go the intended distance.

In the arrangement shown, the improved sole 28 geometry of the golf club head 14 provides more surface area in the forward portion of the sole 28 in a curved fashion. This increases the effective bounce, which limits divot depth, provides a smooth entry and exit of the divot, maintains more speed through impact, limits the severity of the chunk shot and naturally gets the ball closer to its intended distance through turf interaction efficiency, consistency, and forgiveness.

Trailing Edge Relief 62:

In one or more arrangements, the improved sole 28 geometry may be complimented by trailing edge relief 62 to produce certain performance benefits that may be desirable to certain golfers. “Trailing edge relief” 62 refers to an upward slope of the sole 28 from the sole contact point 40 to the trailing edge point 38. Having a shallow or low trailing edge relief angle (e.g., less than 5 degrees) in combination with the improved sole 28 geometry (e.g., increased sole camber percentage with a sole width 48 of less than 15 mm) provides for more sole 28 stability through impact with the golf ball and through the turf. Having a high trailing edge relief 62 angle (e.g., greater than 5 degrees) will create less stability through the divot, which creates more shot-making versatility of the wedge. The greater the trailing edge relief 62 angle, the more shot-making versatility the wedge has. A higher trailing edge relief 62 angle is advantageous for a golfer who opens the strike face 18 of the wedge during impact with the golf ball, which increase the dynamic loft and effective bounce to hit higher, shorter, softer-landing golf shots, notably the flop shot or shots with an open face. The removal of material due to a higher trailing edge relief 62 angle allows the face to be opened easier for flop shots. A lower trailing edge relief 62 angle can prevent a golfer from opening the strike face 18 of the wedge because it can create too much effective bounce. This does not allow the golfer to hit as many high, short, and soft-landing golf shots due to the leading edge 32 being too high at impact with the golf ball. This prevents the golfer from opening the strike face 18 to its maximum.

Measuring Sole Camber Percentage:

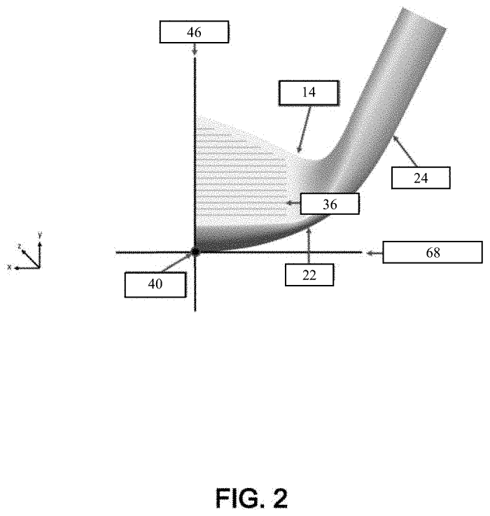

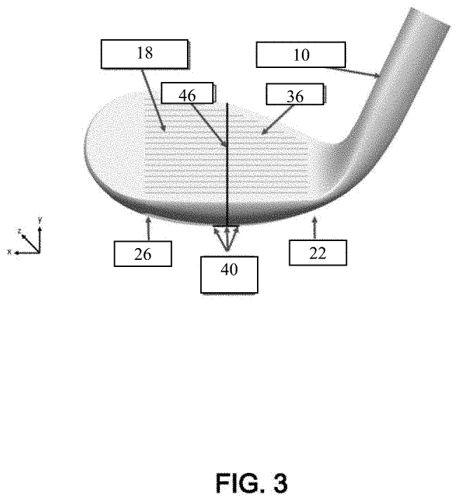

Sole camber percentage is easily obtained by 3D scanning, importing into a CAD program, slicing the golf club head 14 on the YZ plane (e.g., at the midline 46 on the strike face 18 of the wedge) to provide a cross section (as shown in FIGS. 2, 3, 5 and 6 as examples). From this cross section, the leading edge point 34, sole contact point 40, sole width bounce line 50, and forward camber line 54, can be identified to determine the sole camber area 58 and bounce triangle area 60 and calculate sole camber percentage as previously described.

Another way to measure sole camber percentage is to take a picture of the wedge in the X axis having the camera on the toe 26 side of the wedge. The forward most point of the leading edge 32 creates the leading edge point 34 and is generally at the midpoint of the score lines 36. In a computer drawing program like Adobe Illustrator, create lines to define the silhouette of the wedge. Export the lines as a DXF or DWG file and import them into a CAD program. Once in the CAD program, position and align the silhouette at the specific loft of the wedge. Using the silhouette, the leading edge point 34, sole contact point 40, sole width bounce line 50, and forward camber line 54 can be identified to determine the sole camber area 58 and bounce triangle area 60 and then used to calculate sole camber percentage as previously described.

### Alternative Arrangement

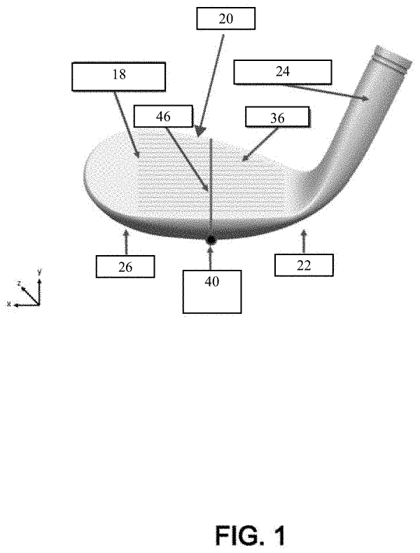

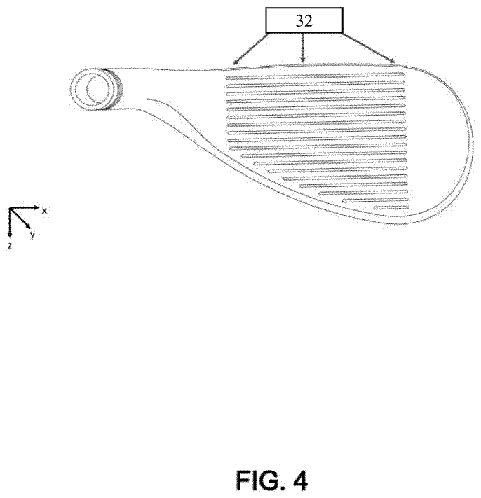

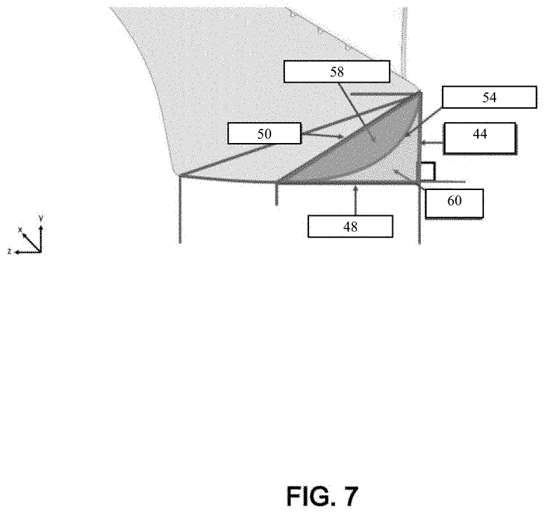

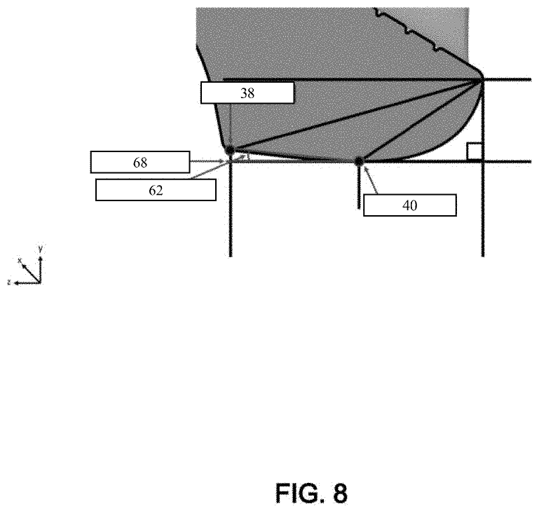

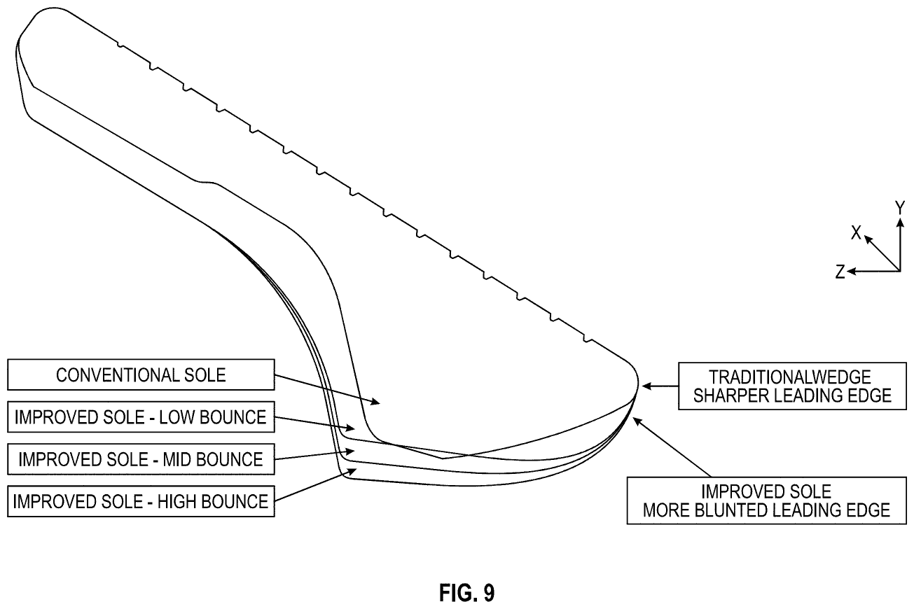

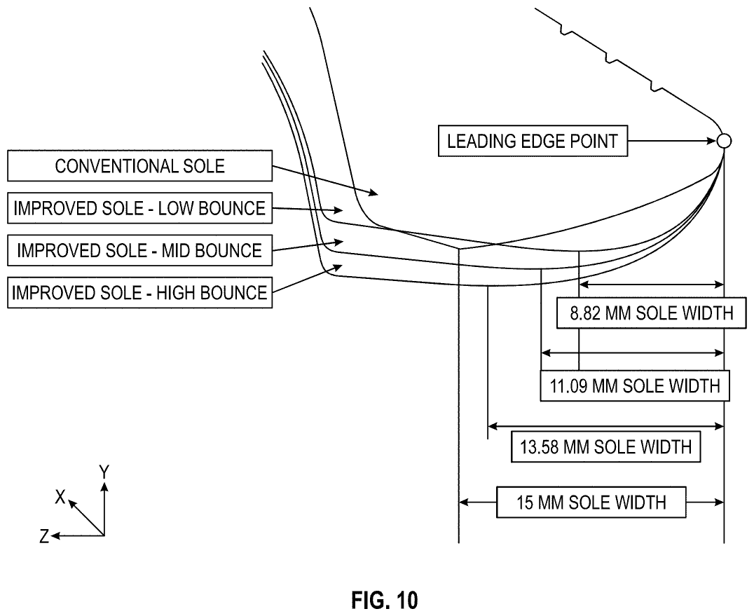

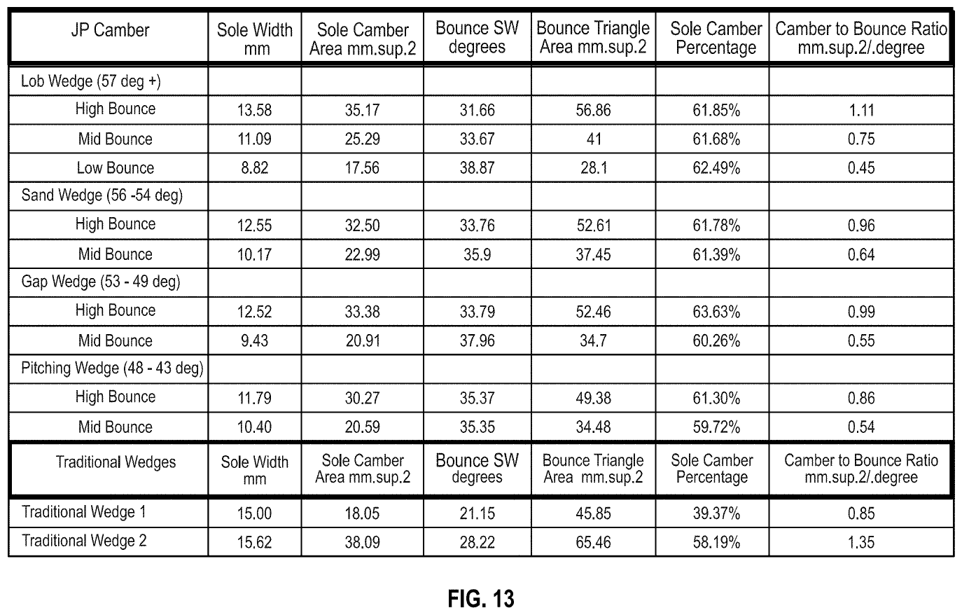

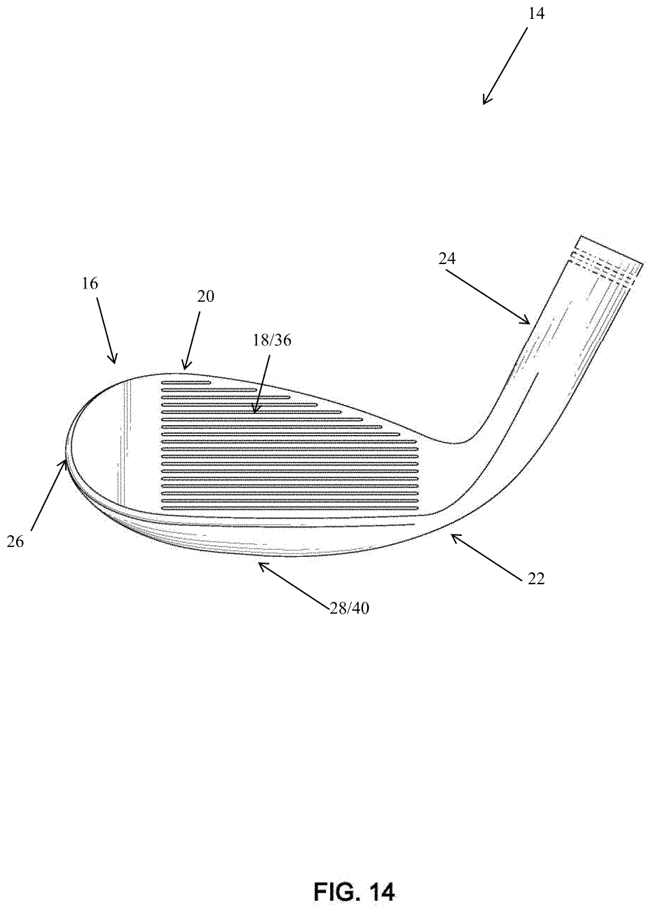

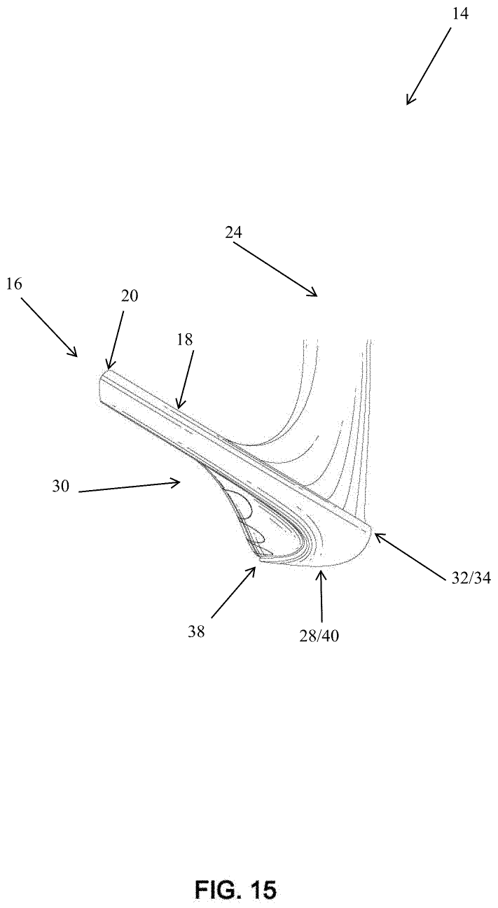

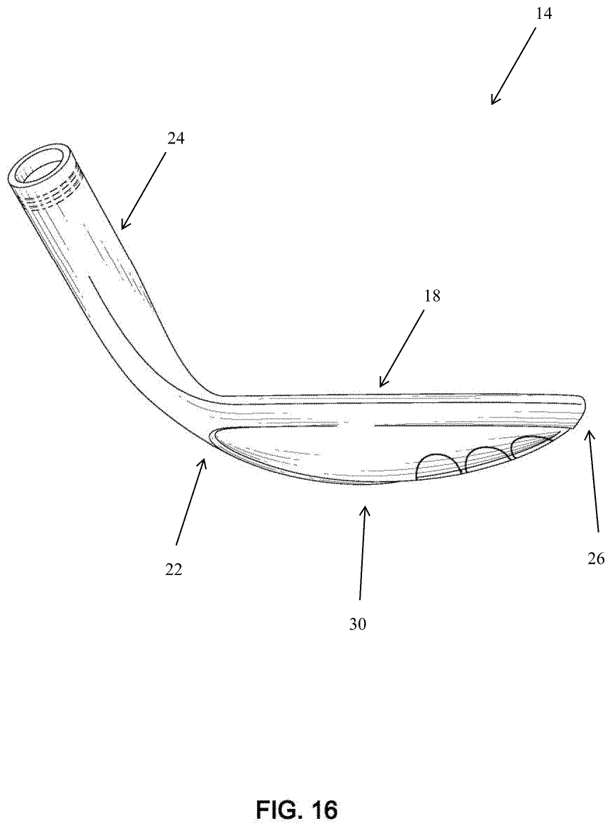

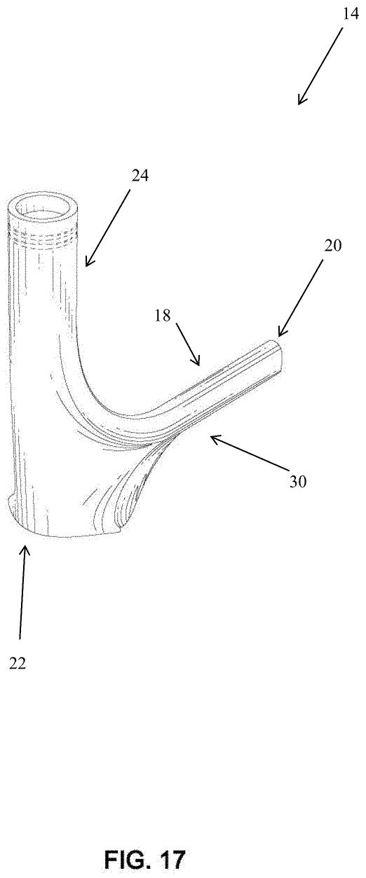

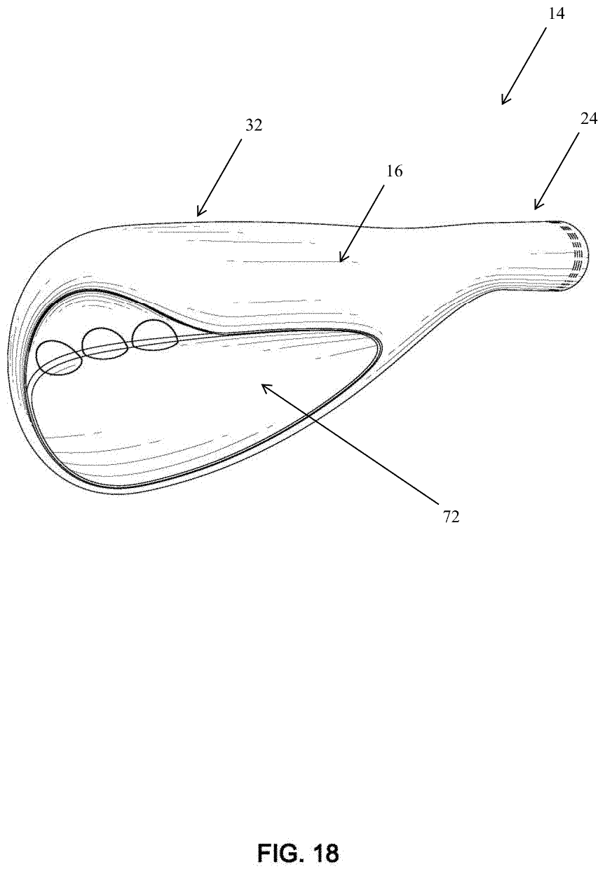

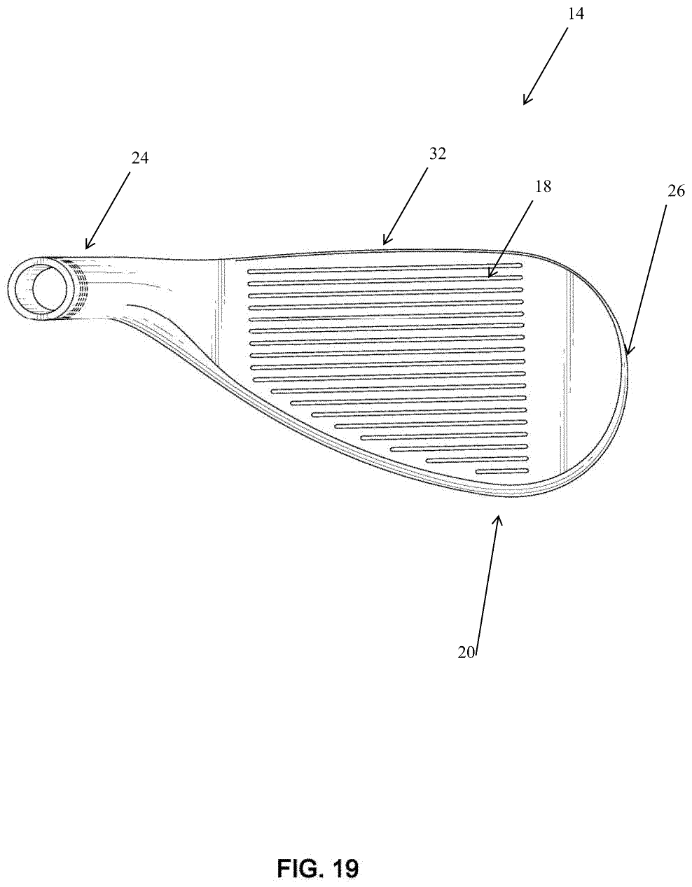

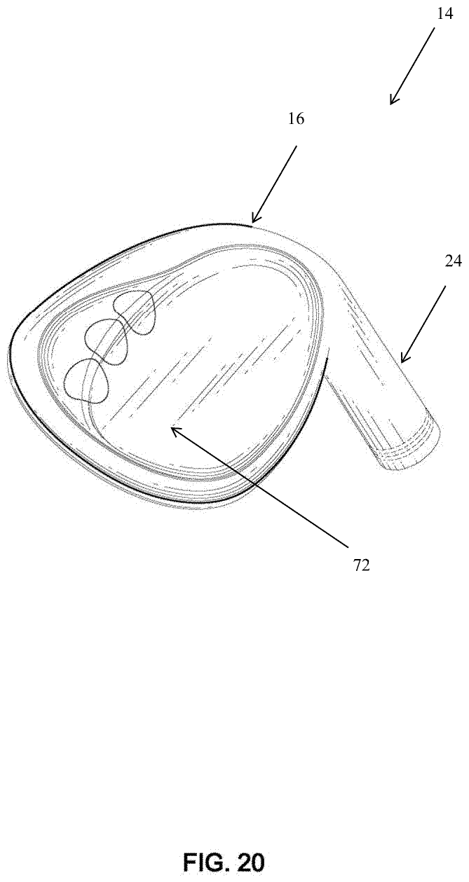

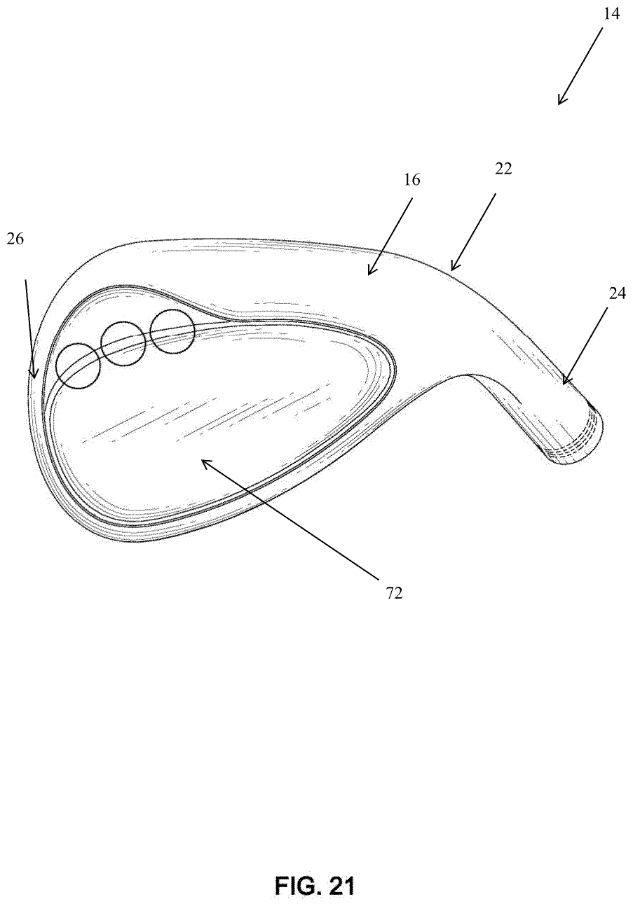

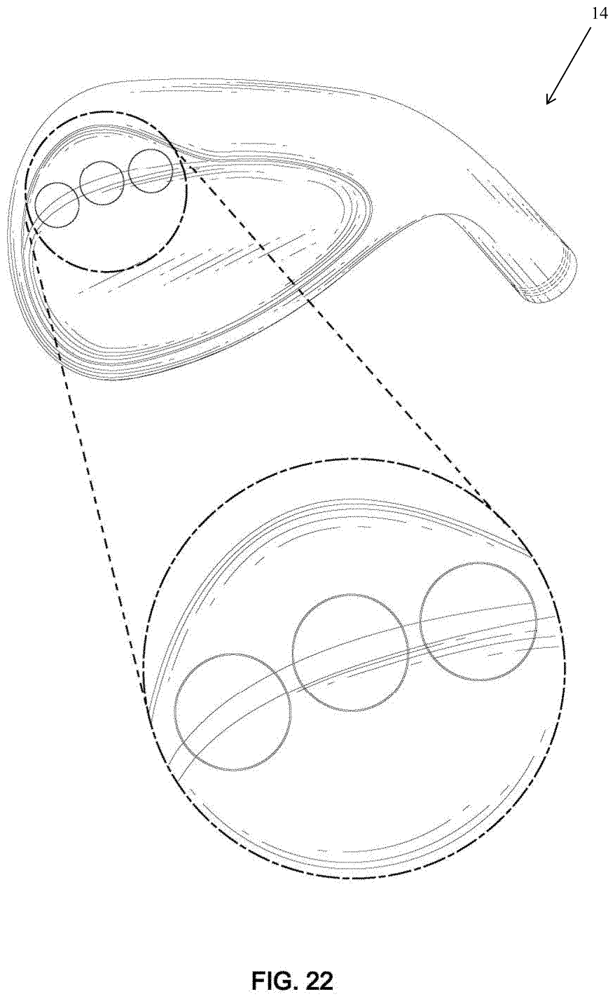

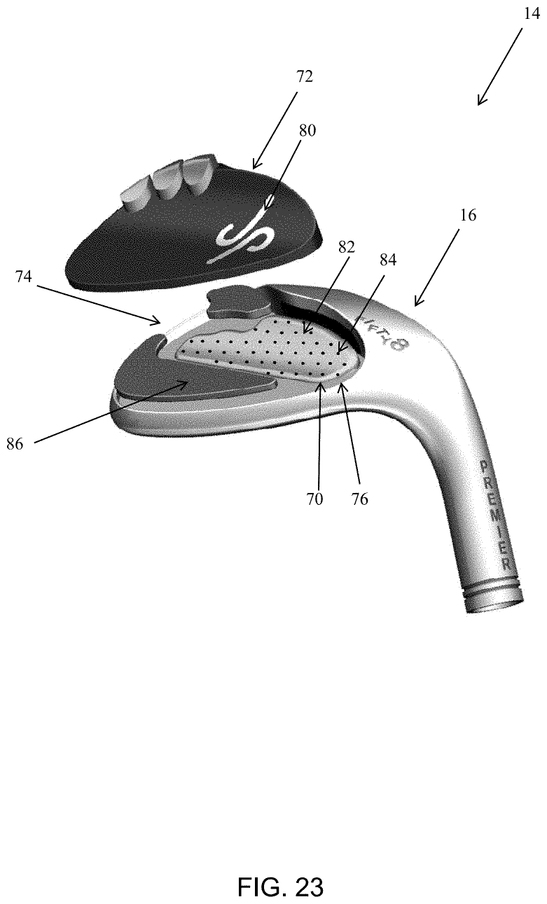

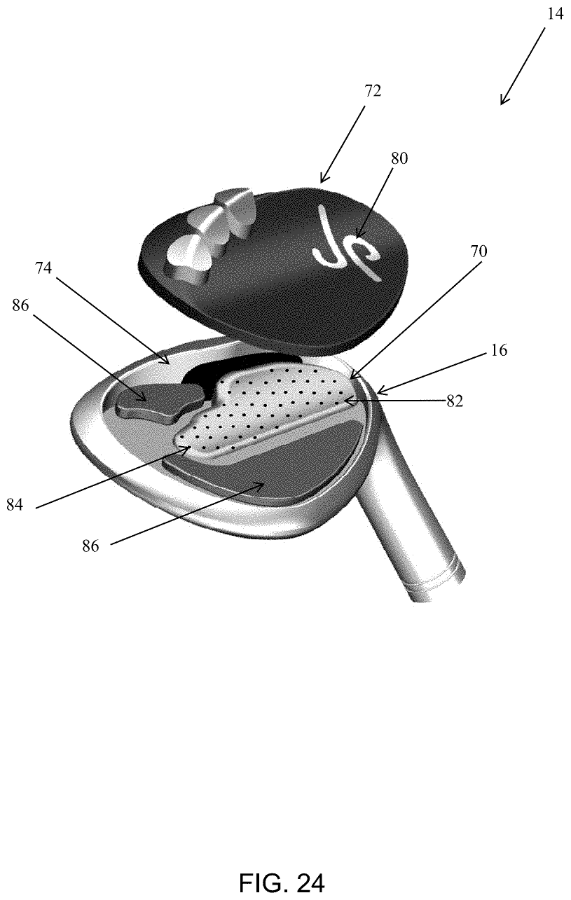

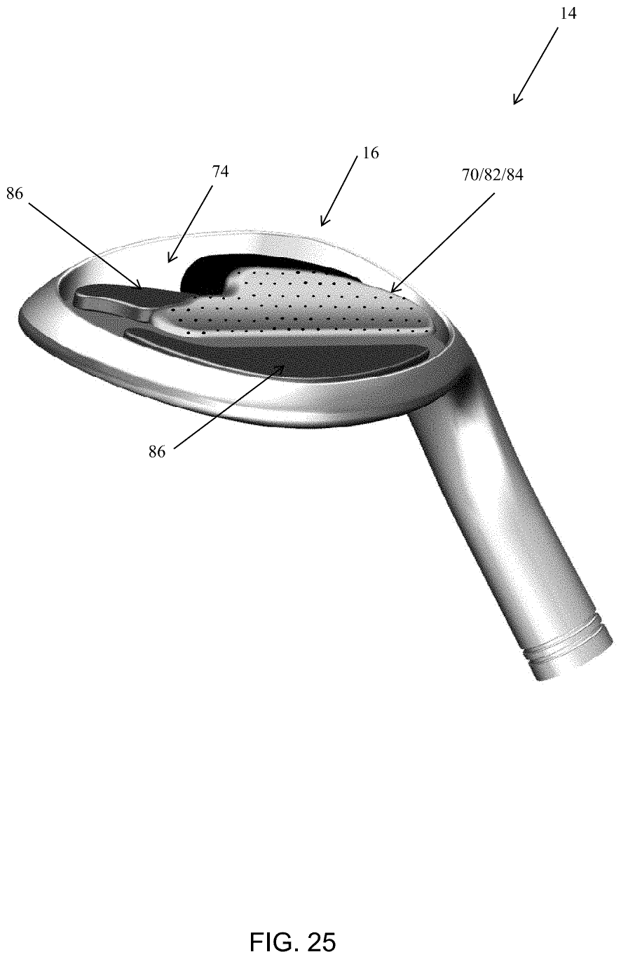

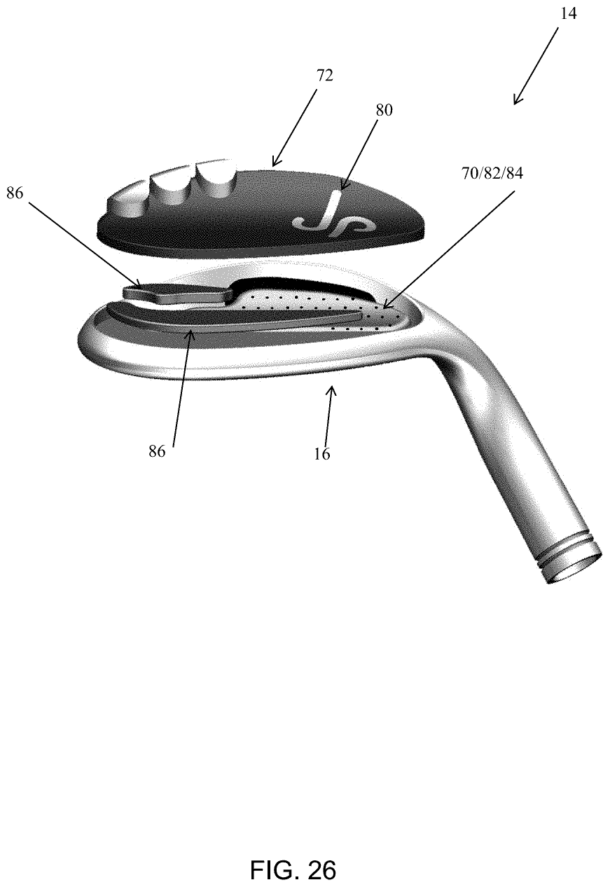

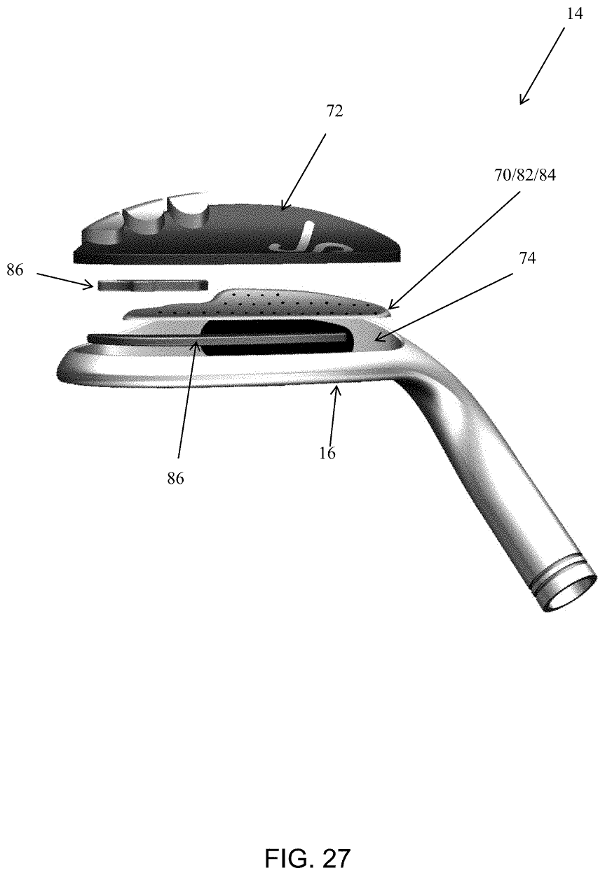

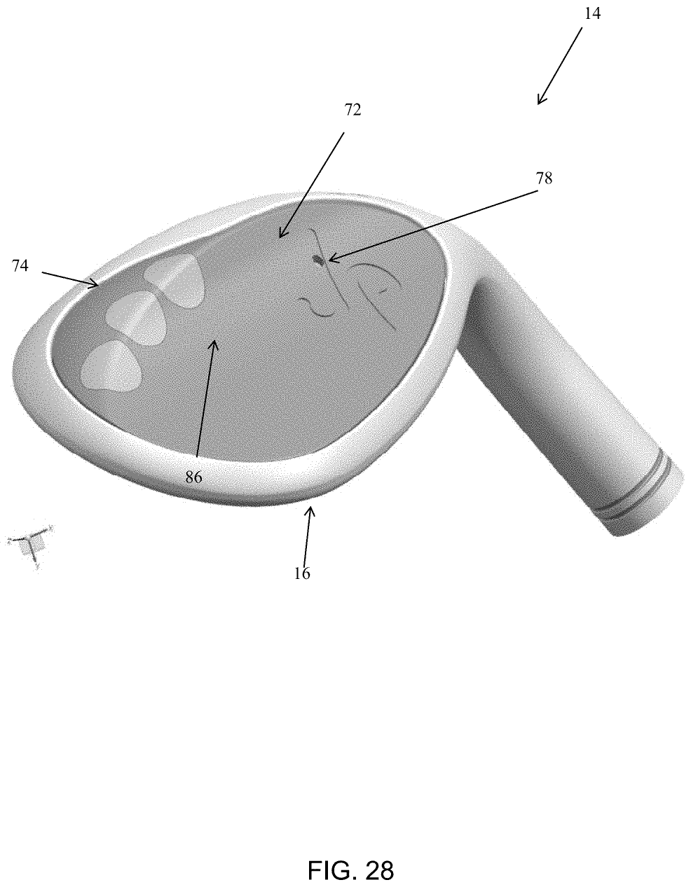

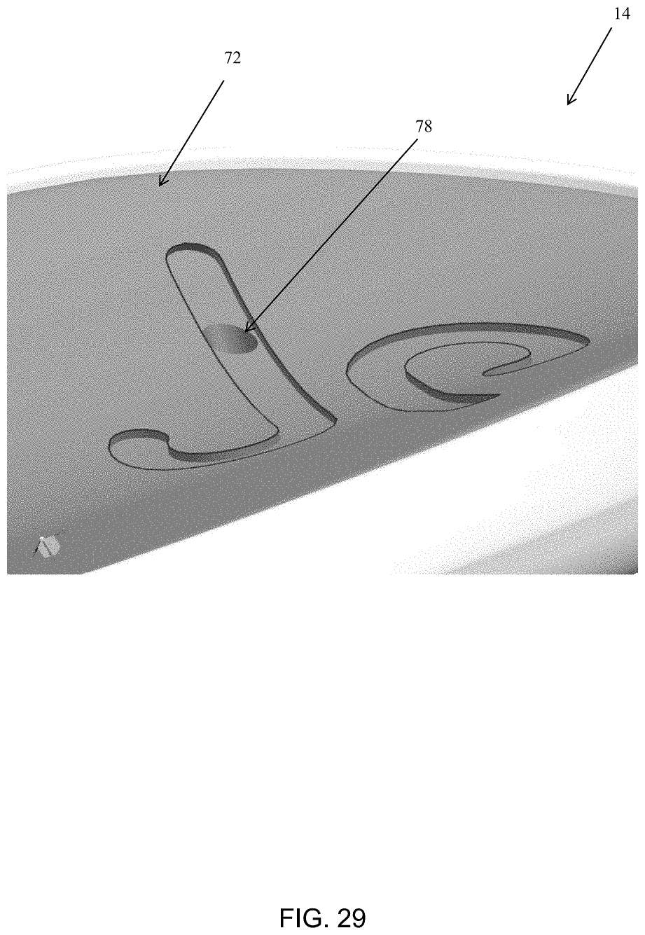

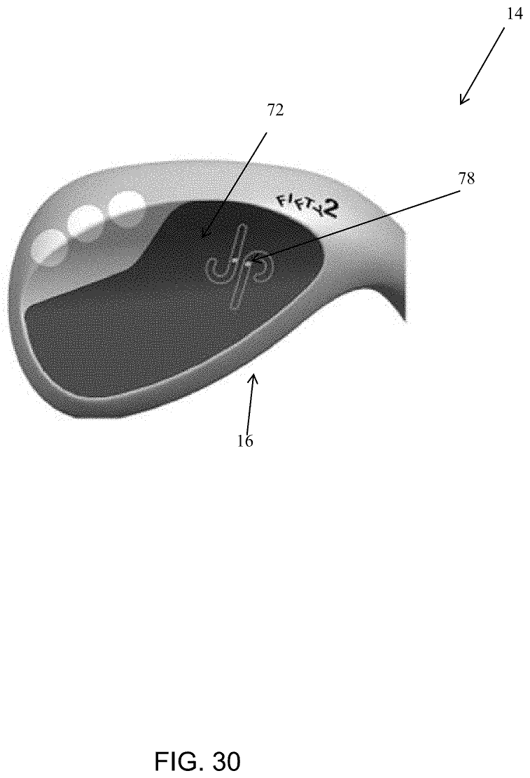

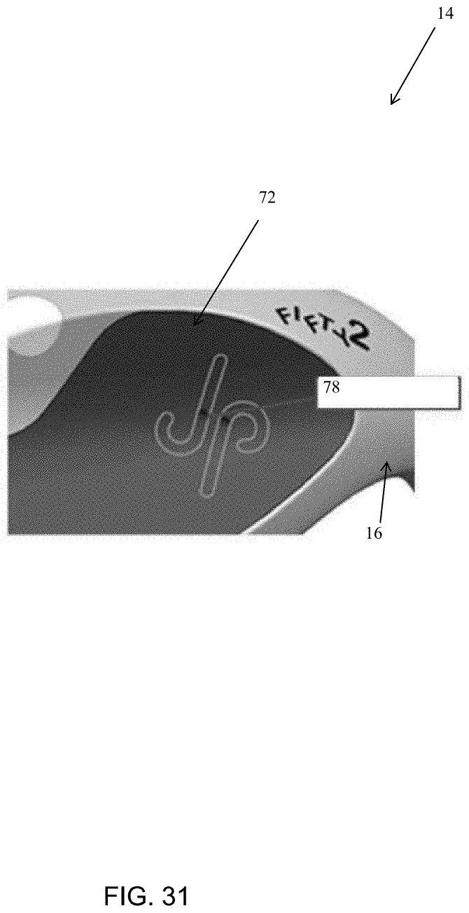

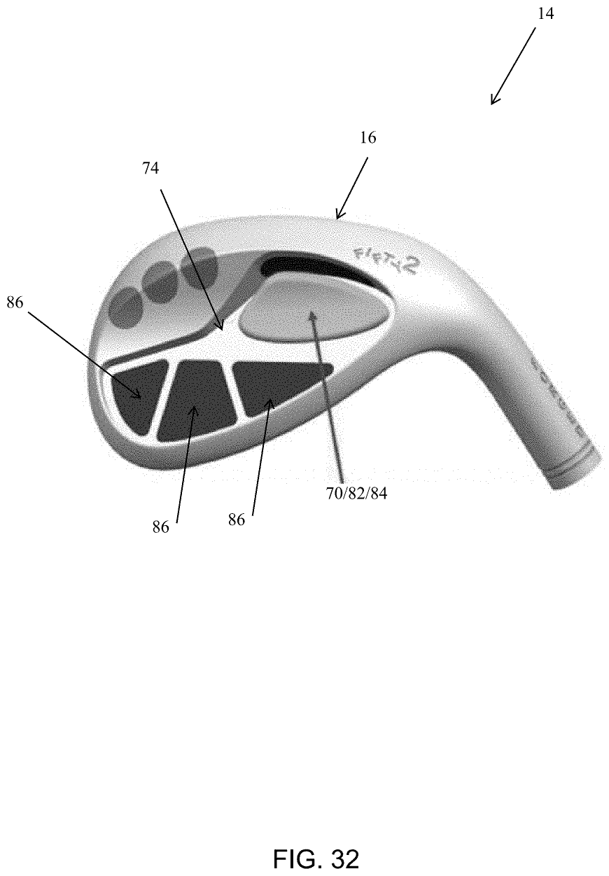

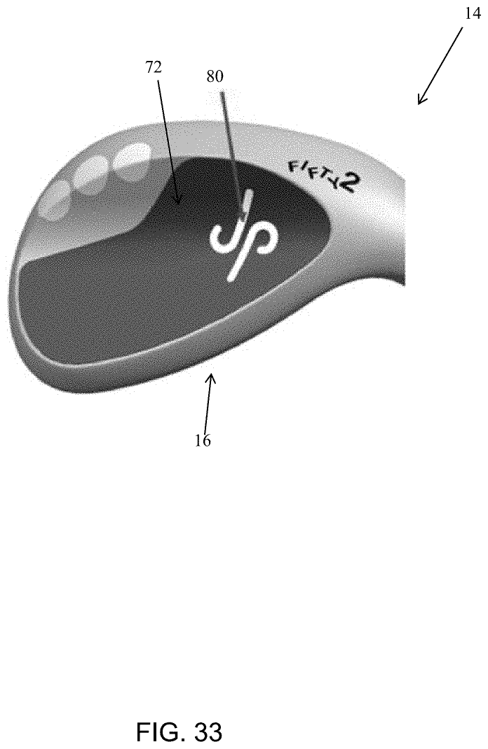

With reference to FIGS. 23-33 various additional features and alternatives of system 10 are presented. Many features of the golf club system 10 presented in FIGS. 23-33 are similar to features presented in golf club system 10 of FIGS. 1-22 and therefore all of the teaching presented herein with respect to FIGS. 1-22 applies equally to and is incorporated into the teaching presented in FIGS. 23-33 unless specifically stated otherwise.

System 10:

In one or more arrangements, a versatile golf club system 10 is provided that permits a manufacturer, a golf shop, a golf pro, a golf club fitter, and/or the end user to adjust the weight and or balance of the golf club head 14 to produce an infinite array of unique custom golf club head 14 configurations to fit any user and provide superior performance.

In one or more arrangements, a golf club head 14 is provided that has one or more cavities 70 that may be filled (e.g., with a polymer 82 only, with metal shot 84 followed by a polymer 82, or with a mixture of polymer 82 and metal shot 84) through a port hole 78 in the exterior surface of the golf club head 14 to increase weight of the golf club head 14 as well as to adjust the balance and center of gravity of the golf club head 14. Cavities 70 of golf club head 14 may be filled in a manner that does not affect weight distribution or alternatively that biases weight distribution away from the original center of mass (e.g., toward the heel 22, toward the toe 26, toward the topline 20, toward the sole 28, toward the leading edge point 34, toward the trailing edge point 34, and/or in any other direction).

Some golf club heads 14 may be manufactured with a single cavity 70 that is later filled with a material epoxy or an epoxy metal powder mixture, for example, to increase weight. However, these designs do not facilitate biasing balance of the golf club heads 14 to provide different swing characteristics. Furthermore, there is a limit to the amount of metal powder that can be added to epoxy before viscosity increases to a point where it is not practical to insert the mixture into a cavity. If mixed prior to injecting, too much metal powder will make the resulting mixture too viscous to inject. As such, there is a practical upper limit to the density of an epoxy and metal powder mixture that can be used to fill such a cavity. Experimentation has shown that even when low viscosity epoxy is used, the upper limit of a metal powder filing that can be added provides a density of approximately 5 g/cc in the resulting mixture. Alternatively, metal powder may be added to the cavity 70 before injecting epoxy. However, due to compactness of metal particles and viscosity of epoxy, epoxy will not be drawn in between the particles by capillary action or fluid flow dynamics to provide a uniform solid body. Instead, pockets of powder will remain which leads to greater volume and less density not to mention leaving cavity 70 not uniformly filled and solid.

It has been surprisingly discovered that a mixture of polymer 82 and metal shot 84 can achieve densities greater than 5 g/cc without inhibiting flow of the mixture.

Polymer 82:

In some various arrangements, the balance of a golf club head 14 may be adjusted by injecting a polymer 82 or mixture of polymer 82 and metal shot 84 into one or more cavities 70. Various arrangements may use various polymers 82 including, but not limited to, for example, various natural and synthetic resins such as acrylic, epoxy, polyethylene, polyurethane, polyamide, polycarbonate, polypropylene, polystyrene, alkyd, and/or silicon resins. In some various arrangements, polymer 82 has a viscosity such that the polymer 82 will be drawn into gaps between adjacent pieces of metal shot 84 via capillary action, fluid flow, or the like. While arrangements are primarily described with reference to adjusting the balance of golf club head 14 by filling a cavity 70 with a polymer 82 and/or mixture of polymer 82 and metal shot 84, embodiments are not so limited. Rather, it is contemplated that a cavity 70 of a golf club head 14 may be filled with any material that transforms from a flowable material to a solid material or semi-solid material including but not limited to, for example, thermoplastic materials, thermoset materials, and/or any other material that can be transformed into a solid within a cavity 70 of a golf club head 14. This curing may occur at room temperature, at an elevated temperature, through an endothermic reaction, through an exothermic reaction or any other reaction or process.

Metal Shot 84:

In one arrangement, metal shot 84 is formed of solid metal particles that are formed in a spherical or generally spherical shape. Successful testing has shown that use of spherical or generally spherical shaped metal shot 84 allows for satisfactory insertion into cavity 70 through port hole(s) 78. Metal shot 84 may be inserted dry, by itself, and followed by polymer 82 or in a mixture with polymer 82. Further successful testing shows use of spherical or generally spherical shaped metal shot 84 allows polymer 82 to coat or cover metal shot 84 and fill the gaps between the pieces of metal shot 84 as well as fill the area between metal shot 84 and cavity 70 thereby fully filling all space or the vast majority of the space within cavity 70 not occupied by metal shot 84. Additionally, successful testing shows use of spherical or generally spherical shaped metal shot 84 allows optimum and/or maximum density of metal shot 84 within cavity 70.

The effectiveness of using spherical or generally spherical shaped metal shot 84 may be due to the fact that polymer 82 may easily flow over the exterior surfaces of metal shot 84. Similarly, the effectiveness of using spherical or generally spherical shaped metal shot 84 may be due to how the metal shot 84 moves, flows, or rolls into and around cavity 70 during insertion. Similarly, the effectiveness of using spherical or generally spherical shaped metal shot 84 may be due to how the metal shot 84 moves, flows or rolls within and around cavity 70 or self-organizes within and around cavity 70 thereby maximizing or optimizing the amount of metal shot 84 within cavity 70. The spherical shape of the metal shot 84 may additionally or alternatively allow it to be loaded into cavity 70 more easily than non-spherical metal shot 84. This is due to the natural tendency and ability of spherical metal shot 84 to roll due to its spherical shape and density. In addition, metal shot 84 that is spherical has a tendency to self-organize itself for maximum density under the force of gravity, again, due to its spherical shape and ability to roll.

While spherical or generally spherical metal shot 84 is shown and primarily discussed, embodiments are not so limited. Rather, it is contemplated that some various arrangements may utilize metal shot 84 having various different shapes such as square, rectangular, egg-shaped, oval, triangular, oblong-shaped, cylindrical, or any other shape or combinations of shapes or mixtures of shapes.

In the arrangement shown and contemplated with spherical or generally spherical shaped metal shot 84, the larger particle size of metal shot 84, the surface structure of metal shot 84, and the larger gaps between metal shot 84 (as compared to using a powdered metal) allows the mixture of polymer 82 and metal shot 84, to remain relatively fluid and permit mixtures with densities greater than 5 g/cc to be injected into cavities 70. Alternatively, in one or more arrangements, metal shot 84 can be poured into one or more cavities 70 prior to injecting a polymer 82. Due to the larger gaps between metal shot 84, polymer 82 may be drawn into the gaps between the metal shot 84 via capillary action, fluid flow dynamics and/or via other properties of polymer 82 being in a liquid state and/or semiliquid state and/or a flowable state when polymer 82 is inserted into cavities 70. That is, metal shot 84 may be inserted into cavity 70 prior to polymer 82, simultaneously with polymer 82, or even after polymer 82.

Prior to injection of polymer 82, metal shot 84 may freely move within cavity 70. In this state, metal shot 84 may self-organize into a maximum-density configuration. In this state, using the force of gravity or other forces such as magnetism depending on the composition of metal shot 84, metal shot 84 may be organized or distributed within cavity 70. That is, as one example, if maximum density is desired, cavity 70 is filled first with metal shot 84 and then polymer 82. Polymer 82 is used to fill the gaps between metal shot 84 pieces and the rest of the open space within cavity 70. In this configuration, metal shot 84 is evenly distributed across cavity 70, fills cavity 70, and is held in place by cured polymer 82. As another example, if maximum density is desired at the toe 26 of a golf club head 14, metal shot 84 is inserted into cavity 70 while the toe 26 is tilted downward. The force of gravity is used to maximize the density of metal shot 84 at the toe 26, and then polymer 82 is used to fill the gaps between metal shot 84 pieces as well as fill the rest of the open space within cavity 70. In this configuration, metal shot 84 is distributed more-heavily toward the toe 26 and is held in place by cured polymer 82. As another example, if maximum density is desired at heel 22 of a golf club head 14, metal shot 84 is inserted into cavity 70 while the heel 22 is tilted downward. The force of gravity is used to maximize the density of metal shot 84 at the heel 22 and then polymer 82 is used to fill the gaps between metal shot 84 pieces as well as fill the rest of the open space within cavity 70. In this configuration, metal shot 84 is distributed more-heavily toward the toe 26 and is held in place by cured polymer 82. Although arrangements may be primarily described and/or illustrated with reference to a process in which a cavity 70 is completely, mostly, or practically filled with metal shot 84, embodiments are not so limited. Rather, it is contemplated that in some various arrangements, cavity 70 may be partially filled with various different amounts of metal shot 84 to achieve a desired mass after polymer 82 is injected into cavity 70.

Upon injection of polymer 82 into cavity 70, after insertion of metal shot 84 within cavity 70, metal shot 84 may move within polymer 82. However this movement is restricted by the fluid dynamics of polymer 82, or, said another way, movement of metal shot 84 is restricted by the flowable properties of polymer 82. Metal shot 84 may continue to move until polymer 82 cures. Polymer 82 may cure into a solid, a semi-solid, a compressible solid, a rigid solid, a flexible solid, or any other form or state which is more-solid than the form or state that the polymer was in before being injected into cavity 70. When polymer 82 cures within cavity 70, metal shot 84 is suspended (which means held in relative position) within cavity 70. This means metal shot 84 is held within cavity 70 and is restricted from movement within cavity 70.

It is contemplated that metal shot 84 may be of any size. In one arrangement, metal shot 84 is contemplated having a diameter of approximately 1 mm. However, any range of size between 0.01 mm and 10 mm is hereby contemplated for use. With that said, a range of size between approximately 0.1 mm and 8 mm is hereby contemplated for use. With that said, a range of size between approximately 0.1 mm and 7 mm is hereby contemplated for use. With that said, a range of size between approximately 0.1 mm and 6 mm is hereby contemplated for use. With that said, a range of size between approximately 0.1 mm and 5 mm is hereby contemplated for use. With that said, a range of size between approximately 0.1 mm and 4 mm is hereby contemplated for use. With that said, a range of size between approximately 0.1 mm and 3 mm is hereby contemplated for use. With that said, a range of size between approximately 0.1 mm and 2.0 mm is hereby contemplated for use. With that said, a range of size between approximately 0.2 mm and 1.5 mm is hereby contemplated for use. With that said, a range of size between approximately 0.5 mm and 1.25 mm is hereby contemplated for use. Again, any other size or range of sizes of is hereby contemplated for use as metal shot 84.

It is hereby contemplated that metal shot 84 may be formed of tungsten or a tungsten alloy which provides maximum density and weight while also being non-toxic and easy to work with. However, metal shot 84 may be formed of any suitable size, shape, design, or material that has a density that is greater than that of the polymer 82. Similarly, various arrangements may use various metal materials to form metal shot 84 including, but not limited to, for example, lead, copper, tungsten, iron, steel, nickel, cobalt, zinc, tin, brass, and/or any other metal or alloy.

Back Insert 72:

In one or more arrangements as shown, as one example, cavities 70 are formed between main body 16 of golf club head 14 and a back insert 72. In the example arrangements, back insert 72 is configured for insertion and adherence in back recess 74. Back recess 74 is located on the back 30 of the main body 16 of a golf club head 14. Back insert 72 is formed of any suitable size, shape or design and is configured to provide one or more cavities 70 to facilitate balancing of the golf club head 14 via injection of a polymer 82 or polymer mixture. In this example arrangement, insert 72 is inserted and adhered to recess 74 in the back of the main body 16 of club head 14. Back insert 72 may be adhered to back recess 74 using various methods including, but not limited to, rivets, pins, clamps, bolts, screws, adhesives, chemical bonding, welding, and/or any other process or means that results in a permanent or semi-permanent connection. In this example arrangement, back insert 72 and/or main body 16 includes recesses 76 that form the cavity 70 when back insert 72 is attached in back recess 74. Additionally or alternatively, golf club head 14 may include one or more cavities 70 in main body 16.

Although some various arrangements may be primarily described and/or depicted with reference to a golf club head 14 having a main body 16 with a back insert 72 inserted in a back recess 74 to form cavity 70, embodiments are not so limited. Rather, it is contemplated that golf club head 14 with cavity 70 may be formed of more or fewer components. For example, it is contemplated that in some arrangements cavity 70 may be formed within main body 16 with back insert 72 omitted. Similarly, it is contemplated that main body 16 may be formed as a unitary component or a combination of multiple separate components that are connected together by one or more fastening mechanisms or methods (e.g., by rivets, pins, clamps, bolts, screws, adhesives, chemical bonding, welding, and/or any other process or means that results in a permanent or semi-permanent connection).

Cavities 70:

Cavities 70 are formed of any suitable size shape or design and located at any position of the back insert 72 or golf club head 14 to facilitate balancing of the golf club head 14 via injection of a polymer or polymer mixture 82. In some example arrangements, the size of cavities 70 is greater than or equal to approximately 0.1 cm³. In some example arrangements, club head 14 includes cavities 70 positioned +/−100 mm in any direction, on any axis or combination of axis from the golf club head's 14 center of gravity. In some example arrangements, golf club head 14 includes cavities 70 positioned at the toe 26, the heel 22, and between the toe 26 and heel 22. As another example, in one or more arrangements, one or more cavities 70 may be positioned closer to a frontal portion of the golf club head 14 and one or more cavities 70 may be positioned closer to a rearward portion of the golf club head 14.

Port Holes 78:

Port holes 78 are formed of any suitable size shape or design and are located at any position on golf club head 14 to provide access to each cavity 70 to facilitate insertion of polymer 82 or a mixture of polymer 82 and metal shot 84. Port holes 78 may provide access to cavities 70 via the surface of main body 16 of golf club head 14, the back insert 72, or both. In one arrangement shown, as one example, back insert 72 includes a single port hole 78 extending from the exterior surface of back insert 72 to cavity 70. However, embodiments are not so limited. Rather, it is contemplated that in some various arrangements, golf club head 14 may include any number of additional port holes 78 to facilitate insertion of polymer 82 and/or metal shot 84 into cavity 70. For example, in one arrangement shown, back insert 72 includes a pair of port holes 78 extending from an exterior surface of back insert 72 to cavity 70. In this example arrangement, air may escape out of one of the pair of port holes 78 while polymer 82 and/or metal shot 84 is injected into the other one of the pair of port holes 78.

Cover 80:

In one or more arrangements, golf club head 14 includes a cover 80, which is positioned over port hole(s) 78. Cover 80 is formed of any suitable size, shape, or design and is configured to seal or cover port holes 78 while providing an aesthetically pleasing appearance. In one arrangement, cover 80 may be formed of a label, paint, a sticker, a logo, welding, an adhesive, or any other member configured to seal or cover port holes(s) 78, or any combination thereof. Alternatively, in one or more arrangements, cover 80 may be omitted. For example, a piece of tape (not shown) may temporarily be placed over a port hole 78 after filling a cavity 70 to keep polymer/polymer mix 82 within the cavity 70 until it is cured. After which, the tape may be removed.

### Example Manufacture and Operation:

As an illustrative example, an example process for manufacture of a golf club head 14 is described. At process block 100, main body 16 of golf club head 14 is forged, cast, machined or otherwise formed. In some arrangements, back recess 74 and/or recesses 76 are machined into the main body 16 after forging at process block 102. In some arrangements, golf club head 14 may include one or more recesses 76 that are not fillable via port holes 78. Such recesses 76 may be filled by a metal insert or polymer fill 86 at process block 104, prior to insertion of back insert 72 into recess 74. At process block 106, back insert 72 is inserted into recess 74 and attached to main body 16. Back insert 72 includes and/or forms one or more cavities 70 on main body 16. Back insert 72 includes one or more port holes 78 extending from each of the one or more cavities 70 to a back surface of the golf club head 14. At process block 108, metal shot 84 and a polymer 82 are inserted into at least one cavity 70 through the port hole(s) 78 connected thereto. In some arrangements, metal shot 84 is inserted into cavity 70 first followed by the polymer 82. In some other arrangements, metal shot 84 may be mixed with polymer 82 prior to insertion into cavity 70. As previously discussed, in various different arrangements, cavities may be filled to increase golf club head 14 weight and/or to bias weight distribution toward the heel 22, toward the toe 26, toward the topline 20, toward the sole 28, toward the leading edge point 34, toward the trailing edge point 38, and/or in any other direction. At process block 110, the polymer 82 is cured. Optionally, at block 112, port hole 78 is sealed. In one or more arrangements, the one or more port holes 78 may be sealed, for example, by placing one or more covers 80 over the one or more port holes 78. Additionally or alternatively, in one or more arrangements, port hole(s) 78 may be sealed by inserting a mechanical member such as a plug, a dowel, a pin, a screw, a bolt, a threaded shaft, a barbed shaft, a friction-fit member, or any other suitably shaped member into port hole 78. Afterward the mechanical member may be cut, ground, or broken off proximate to the surface of the golf club head 14 and/or sanded or polished flush with the surface of the golf club head 14. The mechanical sealing member may itself be adhered in place such as through the use of adhesive, glue, welding or the like. This configuration may provide a more robust and secure method of sealing port hole 78.

### Example Instructions for Fitting:

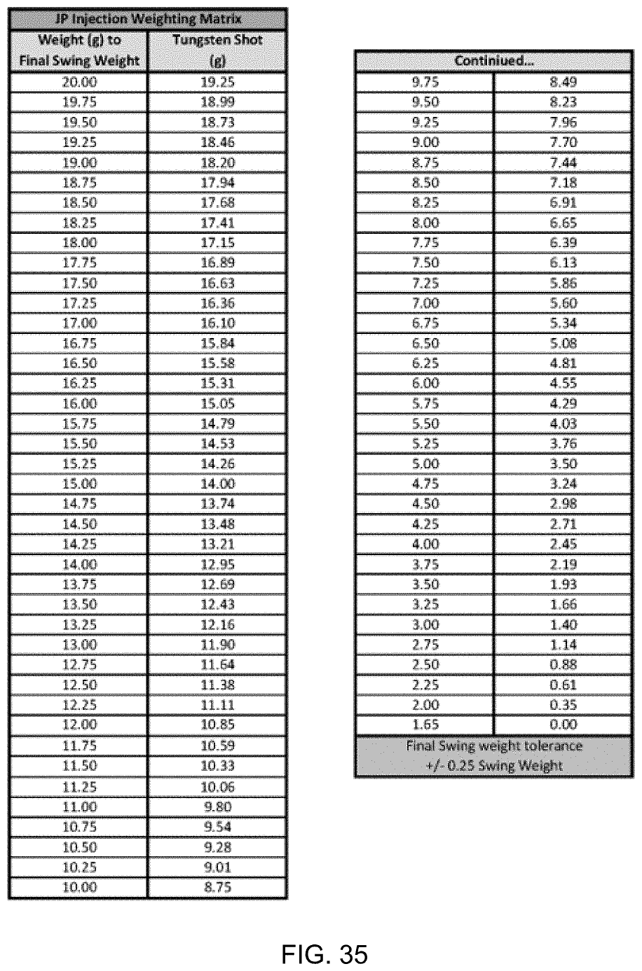

In one or more arrangements, golf club head 14 is sold having empty cavities 70 that may be filled with metal shot 84 and/or a polymer 82 by a golf shop, a golf pro, a golf club fitter, and/or the end user to adjust the weight and or balance of the golf club head 14 to produce an unique custom golf club head 14 specifically tailored to an individual. The following steps outline an example procedure for assembly and fitting of a golf club head in accordance with one or arrangements.
Step 1. Remove golf club head 14 and other contents from package.
Step 2. Weigh the gold club head 14 for your reference if you desire to determine the overall head weight of your completed golf club.
Step 3. Build the golf club with desired shaft and grip to your desired specs.
   a. Install shaft and ferrule/socket with golf club building epoxy.
   b. Allow epoxy to cure.
   c. Bend assembled golf club to desired loft and lie angle.
      i. Do this before cutting the shaft to length to ensure exact desired length.
   d. Cut golf club to length.
   e. Turn ferrule/socket with linen belt to be flush with the outside diameter of the hosel.
   f. Install grip and grip tape to desired grip size specifications.
   g. Clean grip solvent residue from the mouth of the grip while wet for easier cleaning of the shaft.
Step 4. Put the assembled golf club onto swing weight scale.
Step 5. Apply double sided grip tape to the face of the gold club head 14.
Step 6. Adhere weight to the double-sided grip tape until you have reached your desired swing weight.
Step 7. Remove the tape and added weight from the face of the gold club head 14 and weigh.
Step 8. Record the weight in grams that it took to reach the desired swing weight.
   a. For example: 11.4 g
Step 9. Refer to the Weighting Matrix shown in FIG. 35 for the amount of tungsten shot to be installed into the golf club head 14.
   a. The matrix considers the weight of the covers 80 and epoxy filler to be inserted into cavities.
Step 10. Put a small mixing cup onto the scale and zero.
Step 11. Pour tungsten shot from the zip lock bag into the cup until it equals the weight prescribed in the Weighting Matrix correlated to the gram weight discovered in step 7.
Step 12. Pinch a crease into the tungsten shot measuring cup with your fingers. This will help for more control of the tungsten shot during the building process.
Step 13. Leave the Tungsten Shot in the cup and set aside.
Step 14. Use tape to mask the golf club head proximate to port holes 78 to ensure protection and easy clean-up.
Step 15. Press tape onto JP Premier to ensure a good bond with the tape and the golf club head 14.
Step 16. Poke a hole with the push rod or toothpick through the port holes 78.
Step 17. Rub the edges of the hole with the push rod or toothpick to clear any tape debris from hole that could restrict the tungsten shot from passing through the hole.
Step 18. Set the funnel onto one of the port holes 78 of the cavity 70 to be filled, then securely hold the funnel in place while performing the following step.
Step 19. Pour tungsten shot into the funnel in a one-by-one stream by tapping your finger on the side of the cup to allow a one-by-one stream of tungsten shot into the funnel and into the through port hole.
Step 20. If the tungsten shot gets blocked in the tip of the funnel at any time, continue to pour tungsten shot into the funnel to fill a ¼ of the funnel.
Step 21. With push rod or toothpick, push and stir the backed-up tungsten shot through the funnel and through the through port 78 hole.
Step 22. Repeat steps 18-20 until all the pre-measured tungsten shot has been installed into the cavity 70.
Step 23. Tighten the green syringe tip onto the syringe.
Step 24. Next, use a mixing cup to mix the 2-part epoxy filler.
Step 25. Mix 2 ml of Part A and 2 ml of Part B of epoxy filler.
Step 26. Since the darker epoxy is not as thick as the clear epoxy, you can re-use a syringe to draw the darker epoxy. Then use the syringe supplied in the kit to draw the clear epoxy and then inject the wedge.
Step 27. Stir the epoxy fill for 10 seconds with the assembled syringe.
Step 28. Draw almost all the mixed epoxy into the syringe from the mixing cup then express back into the cup. Do this 3 times. Keep the tip of the syringe at the bottom of the mixing cup and always keep a small amount of epoxy in the cup during this process, this will help restrict air bubbles forming during the mixing process.
Step 29. Draw 0.5 ml of epoxy filler into the syringe.
Step 30. Insert the green syringe tip into the port hole 78.
Step 31. Tilt the toe of the wedge down during injection. Inject 0.5 ml of epoxy filler slowly into cavity.
   a. Please note: Never inject more than 0.5 ml of epoxy filler into the cavity at one time. If you do this, you may run into difficulties properly installing the epoxy filler.
Step 32. Repeat No. 29 a second time.
Step 33. Take golf club and drop the toe down and the heel up, repeat this a few times. This helps the epoxy coat the tungsten shot.
Step 34. Instead of tilting the toe down, keep the wedge more level during the third 0.5 ml injection. Inject the wedge. You may start to notice epoxy starting to come out of the second port hole 78 connected to the cavity 70 being filled, this is good. This second port hole 78 is used for an air release during injection. As the epoxy overflows out of the second port hole 78, tilt the wedge so the epoxy runs into the collection pocket made of tape then tile the wedge back to level.
Step 35. Continue to inject 0.5 ml of epoxy filler until the cup is empty. Care may be taken not to inject bubbles from the bottom of the mixing cup during your last 0.5 ml injection. It may be helpful to leave a little bit in the cup for example 0.2 ml-0.3 ml.
Step 36. On your final injection, leave the syringe pressed firmly into the wedge to plug the first port hole 78. Then take a toothpick and plug the second air release port hole 78.
Step 37. Set the golf club aside for about 20 minutes, the epoxy will set and becomes a soft solid.
Step 38. When you remove the syringe, if epoxy filler starts to come out of the port hole 78, quickly plug it with the syringe again. When the epoxy filler does not come out of the hole when the syringe is removed, then it is ready to be cleaned.
Step 39. Remove the syringe, toothpick and tape.
Step 40. Use toothpick to scrape the sidewalls of the golf club head to remove epoxy. It is helpful to do this as soon as epoxy does not come out of the hole when the syringe is removed for easiest cleanup.
Step 41. Use a dry Q-tip to remove excess epoxy filler.
Step 42. Then us Q-tip and acetone to thoroughly clean the surface of the JP logo.
Step 43. Clean entire surface to make sure all epoxy residue has been removed.
Step 44. When the golf club head 14 has been cleaned with acetone of any epoxy, install cover 80.
Step 45. To install cover 80, remove part of the adhesive backing of the one letter of the cover 80.
Step 46. With the toothpick and your finger, press the cover 80 against the toothpick. Hold steady and remove the entire backing. Now, the badge should be adhered to the toothpick.
Step 47. Insert the edge of the bottom of the cover 80 into the recess for the cover 80.
Step 48. Roll the toothpick off the cover 80 and lay the cover 80 into the cover recess. Use the toothpick to adjust and set the cover 80 in place as required.
Step 49. Once in place, make sure the ends of the cover 80 is in position in its recess in by using and gently press the ends down with the toothpick.
Step 50. Use supplied Q-tip(s) to the firmly press the entire surface of the cover 80 to adhere the cover 80 to the golf club head 14.
Step 51. Repeat steps 39-44 for other covers 80 (if applicable).
Step 52. After installation of cover(s) 80, clean and polish golf club head 14 with buffing rag and a metal polishing compound if desired.
Step 53. Use acetone to polish the ferrule/socket.

However, the embodiments are not so limited to the above assembly and fitting process. Rather, it is contemplated that fitting may be performed with various different procedures having one or more steps omitted in including additional or alternate steps.

From the above discussion, it will be appreciated that the disclosed golf club head 14 arrangements improve upon the state of the art. Specifically, various arrangements improve manufacturing and versatility of golf clubs.

One or more arrangements provide a golf club head: that facilitates production of a plurality of golf club heads having various different weight distributions; that may be configured after manufacture to produce golf club heads for a plurality of different balance characteristics; that permits biasing weight of the golf club head toward the heel; that permits biasing weight of the golf club head toward the toe; that permits weight and/or balance of the golf club head to be permanently adjusted via a professional fitting service; for adjusting weight and/or balance of the golf club head that is intuitive to use; for adjusting weight and/or balance of the golf club head that is easy to use; that has a long useful life; that is strong, robust, and durable; and/or that is high quality. These and other objects, features, or advantages of the disclosure will become apparent from the specification, figures, and claims.

What is claimed:

1. A golf club head, comprising:
a striking face portion located at a frontal portion of the golf club head;
a topline located at an upper portion of the golf club head;
a heel portion located at a proximal end of the golf club head, the heel portion adapted to receive a shaft;
a toe portion located at a distal end of the golf club head opposite the heel portion;
a sole, located at a lower portion of the golf club head;
a first cavity positioned within the golf club head;
a mixture of metal shot and a polymer positioned within the first cavity;
a first port hole extending from the first cavity to an exterior surface of the golf club head;
wherein the first port hole is configured to facilitate insertion of the metal shot of the mixture into the first cavity;
wherein the first port hole is configured to facilitate insertion of the polymer of the mixture into the first cavity.

2. The golf club head of claim 1, further comprising:
a second cavity positioned in the toe portion of the golf club head;
a third cavity positioned in the heel portion of the golf club head;
a second port hole extending from the second cavity to the exterior surface of the golf club head to facilitate injection of the polymer into the second cavity;
a third port hole extending from the third cavity to the exterior surface of the golf club head to facilitate injection of the polymer into the third cavity;
wherein the first cavity is positioned between the second cavity and third cavity.

3. The golf club head of claim 1, further comprising:
a second port hole extending from the first cavity to the exterior surface of the golf club head;
wherein the second port hole is configured to permit air to escape from the first cavity as the metal shot and the polymer are inserted into the first cavity via the first port hole.

4. A golf club head, comprising:
a striking face portion located at a frontal portion of the golf club head;
a topline located at an upper portion of the golf club head;
a heel portion located at a proximal end of the golf club head, the heel portion adapted to receive a shaft;
a toe portion located at a distal end of the golf club head opposite the heel portion;
a sole, located at a lower portion of the golf club head;
a first cavity positioned within the golf club head;
a first port hole extending from the first cavity to an exterior surface of the golf club head;
wherein the first port hole is configured to facilitate insertion of a polymer into the first cavity.

5. The golf club head of claim 4,
wherein the first port hole is configured to facilitate insertion of metal shot into the first cavity;
wherein when the metal shot and the polymer are inserted into the first cavity through the first port hole, the polymer is cured and suspends the metal shot within the first cavity.

6. The golf club head of claim 4, further comprising:
a second cavity positioned within the golf club head;
a second port hole extending from the second cavity to the exterior surface of the golf club head to facilitate insertion of polymer and metal shot into the second cavity.

7. The golf club head of 4, further comprising:
a second cavity positioned in the toe portion of the golf club head;
a third cavity positioned in the heel portion of the golf club head;
a second port hole extending from the second cavity to the exterior surface of the golf club head to facilitate injection of the polymer into the second cavity;
a third port hole extending from the third cavity to the exterior surface of the golf club head to facilitate injection of the polymer into the third cavity;
wherein the first cavity is positioned between the second cavity and third cavity.

8. The golf club head of claim 4, further comprising:
a second cavity positioned at a forward position of the golf club head;
a third cavity positioned at a rearward position of the golf club head;
a second port hole extending from the second cavity to the exterior surface of the golf club head to facilitate injection of the polymer into the second cavity;
a third port hole extending from the third cavity to the exterior surface of the golf club head to facilitate injection of the polymer into the third cavity;
wherein the first cavity is positioned between the second cavity and third cavity.

9. The golf club head of claim 4, further comprising:
a second cavity positioned at an upper position of the golf club head;
a third cavity positioned at a lower position of the golf club head;
a second port hole extending from the second cavity to the exterior surface of the golf club head to facilitate injection of the polymer into the second cavity;
a third port hole extending from the third cavity to the exterior surface of the golf club head to facilitate injection of the polymer into the third cavity;
wherein the first cavity is positioned between the second cavity and third cavity.

10. The golf club head of claim 4, further comprising:
a second cavity in the golf club head;
a third cavity in the golf club head;
a second port hole extending from the second cavity to the exterior surface of the golf club head to facilitate injection of the polymer into the second cavity;
a third port hole extending from the third cavity to the exterior surface of the golf club head to facilitate injection of the polymer into the third cavity;
wherein one of the first cavity, the second cavity, and the third cavity contain a mixture of the polymer and a metal shot;
wherein two of the first cavity, the second cavity and the third cavity contain the polymer without the metal shot.

11. The golf club head of claim 4, further comprising:
a second cavity in the golf club head;
a third cavity in the golf club head;
a second port hole extending from the second cavity to the exterior surface of the golf club head to facilitate injection of the polymer into the second cavity;
a third port hole extending from the third cavity to the exterior surface of the golf club head to facilitate injection of the polymer into the third cavity;
wherein two of the first cavity, the second cavity, and the third cavity contain a mixture of the polymer and a metal shot;
wherein one of the first cavity, the second cavity, and the third cavity contain the polymer without the metal shot.

12. The golf club head of claim 4, further comprising:
a second cavity in the golf club head;
a third cavity in the golf club head;
a second port hole extending from the second cavity to the exterior surface of the golf club head to facilitate injection of the polymer into the second cavity;
a third port hole extending from the third cavity to the exterior surface of the golf club head to facilitate injection of the polymer into the third cavity;
wherein the first cavity, the second cavity, and the third cavity contain a mixture of the polymer and a metal shot.

13. The golf club head of claim 4, wherein the first cavity is located within 100 mm from the center of gravity of the golf club head.

14. The golf club head of claim 4, further including a mixture positioned within the first cavity;
wherein the mixture includes the polymer and metal shot;
wherein the mixture cures into a solid state within the first cavity;
wherein the mixture has a density that is greater than 5 g/cc.

15. The golf club head of claim 4, further including a mixture positioned within the first cavity;
wherein the mixture includes the polymer and metal shot;
wherein the mixture cures into a solid state within the first cavity;
wherein the mixture has a density that is greater than 6 g/cc.

16. The golf club head of claim 4, further including a mixture positioned within the first cavity;
wherein the mixture includes the polymer and metal shot;
wherein the mixture cures into a solid state within the first cavity;
wherein the mixture has a density that is greater than 8 g/cc.

17. The golf club head of claim 4, further including a mixture positioned within the first cavity;
wherein the mixture includes the polymer and metal shot;
wherein the mixture cures into a solid state within the first cavity;
wherein the mixture has a density that is greater than 10 g/cc.

18. The golf club head of claim 4, further comprising an insert positioned in a recess of a main body of the golf club head; and
wherein the first cavity is formed by and is positioned between the insert and the main body.

19. The golf club head of claim 4, further comprising:
a second port hole extending from the first cavity to the exterior surface of the golf club head;
wherein the second port hole is configured to permit air to escape from the first cavity as the metal shot and the polymer are inserted into the first cavity via the first port hole.

20. A method for manufacture of a golf club head, comprising:
providing a golf club head including a main body having:
a striking face portion located at a frontal portion of the golf club head;
a topline located at an upper portion of the golf club head;
a heel portion located at a proximal end of the golf club head, the heel portion adapted to receive a shaft;
a toe portion located at a distal end of the golf club head opposite the heel portion;
a sole, located at a lower portion of the golf club head;
a first cavity positioned within the golf club head;
a first port hole extending from the first cavity to an exterior surface of the golf club head;
wherein the first port hole is configured to facilitate insertion of a polymer and metal shot into the first cavity; and
inserting the metal shot into the first cavity; and
inserting the polymer into the first cavity.

21. The method of claim 20, wherein the providing a golf club head includes:
forming the main body
machining a recess in a back of the main body; and
attaching an insert to the main body in the recess;
wherein attachment of the insert to the main body forms a first cavity in the golf club head;
wherein the insert has the first port hole extending from the first cavity to an exterior surface of the golf club head.

22. The method of claim 20, wherein the golf club head includes:
a first component having a flat golf club face and a hosel connected to the flat golf club face;
a second component having a sole and a back of the golf club head;
wherein the second component is welded to the first component;
wherein the golf club head includes a second cavity and a third cavity;
wherein at least one of the first cavity, the second cavity, and the third cavity are positioned within the first component;
wherein at least one of the first cavity, the second cavity, and the third cavity are positioned between the first component and the second component;
wherein at least one of the first cavity, the second cavity, and the third cavity are positioned within the second component.

23. The golf club head of claim 20, wherein the metal shot is tungsten shot.

24. The golf club head of claim 20, wherein the main body has a second cavity;
wherein the main body has a second port hole extending from the second cavity to the exterior surface of the golf club head to facilitate insertion of a polymer into the second cavity;
further comprising inserting the polymer into the second cavity.

25. The golf club head of claim 20, further comprising covering the first port hole with a cover.

26. The golf club head of claim 20, further comprising inserting a plug into the first port hole.

27. The method of claim 20, wherein the polymer is inserted into the first cavity after the metal shot is inserted into the first cavity; and
the inserted polymer is drawn into and fills spaces between the metal shot via capillary action.
